(19) United States
(12) Patent Application Publication
(10) Pub. No.: US 2026/0340696 A1
(43) Pub. Date: Oct. 29, 2026

(54) ARTIFICIAL INTELLIGENCE (AI) NEGOTIATION AGENT

(71) Applicant: eBay Inc., San Jose, CA (US)

(72) Inventor: Shiwam Mittal, Santa Clara, CA (US)

(21) Appl. No.: 19/188,266

(22) Filed: Apr. 24, 2025

(51) Int. Cl. G06Q 30/0601; G06Q 30/0201

(52) U.S. Cl. CPC G06Q 30/0611; G06Q 30/0206

(57) ABSTRACT

A message from a first user for sending to a second user is received via a user interface of a user device of the first user. The message pertains to an item from an item listing. The message is classified, by a first machine learning model trained to classify an intention of messages, as requested price negation for the item. Context for the requested price negotiation for the item is generated based on the classification of the message by the first machine learning model. A second machine learning model generates a response to the message based on the context. The response to the message is provided, via the user interface of the user device, to the first user on behalf of the second user.

### TECHNICAL FIELD

The present disclosure generally relates to data processing using machine learning (ML) technologies. More particularly, various embodiments described herein provide for systems, methods, techniques, instruction sequences, and devices for facilitating price negotiation using an artificial intelligence (AI) negotiation agent.

### BACKGROUND

Online marketplaces (also referred to as “e-commerce marketplaces” or “e-commerce platforms,” among other terminology) provide digital platforms where buyers and sellers can engage in commercial transactions for goods and services (collectively referred to as “items” herein) over the internet. Many e-commerce platforms include integrated messaging systems that enable direct communication between buyers and sellers, allowing them to negotiate prices, discuss product details, arrange shipping, and address concerns throughout the transaction process.

Typical negotiation processes on conventional e-commerce platforms suffer from significant technical inefficiencies that create friction, reduce trust, and frequently result in lost transactional opportunities. Conventional negotiation methods on e-commerce platforms typically involve multiple rounds of back-and-forth messaging between users. This process is usually completely manual and inherently time-consuming, with each party waiting for responses that may take hours or even days to arrive. The delay between messages not only extends the time-to-deal closure but also increases the likelihood that users will abandon the negotiation entirely and seek alternatives elsewhere. For users engaging in multiple concurrent negotiations, the time investment becomes particularly burdensome, limiting their ability to engage effectively. Existing solutions have attempted to address these challenges through basic automation tools or fixed pricing rules, but these approaches lack the sophistication needed to navigate the complex dynamics of buyer-seller negotiations. Rule-based systems cannot adapt to the nuanced contexts of individual negotiations, while simple automation tools fail to incorporate the rich data needed for truly optimized outcomes. The result is a negotiation environment that remains inefficient, frustrating, and frequently unsuccessful in completing transactions.

In addition, while the e-commerce messaging systems facilitate communications that are important to marketplace functionality, such as price negotiations, users can and often do utilize these messaging systems to engage in deceptive price manipulation tactics that erode trust and distort fair pricing dynamics within the online marketplaces. For example, buyers may pressure sellers into unnecessary discounts by falsely claiming they found better deals elsewhere, while sellers employ similar tactics to justify inflated prices or create a false sense of urgency. These manipulative practices lead to financial losses for both types of users —buyers overpay due to misleading seller claims, and sellers experience reduced profit margins based on fabricated buyer assertions. These deceptive practices create an environment where pricing is based on manipulation rather than actual market value, leading to increased disputes, operational overhead, and diminished trust in the marketplace ecosystem.

### BRIEF DESCRIPTION OF THE DRAWINGS

The present disclosure will be understood more fully from the detailed description given below and from the accompanying drawings of various embodiments of the disclosure. Some embodiments are illustrated by way of examples, and not limitations, in the accompanying figures.

FIG. 1 is a block diagram showing an example network environment that includes a messaging system, according to various examples of the present disclosure.

FIG. 2 is a block diagram illustrating components of an example messaging system, according to various examples of the present disclosure.

FIG. 3 is a data flow diagram illustrating a flow of operations in an example ML-based process for detecting and handling attempted price manipulation in messages exchanged between users of the messaging system, according to various examples of the present disclosure.

FIG. 4 is a data flow diagram illustrating a flow of operations in an example process for facilitating price negotiation using an AI negotiation agent, according to various examples of the present disclosure.

FIGS. 5-7 are flowcharts illustrating an example method for detecting and handling attempted price manipulation in messages exchanged between users of the messaging system, according to various examples of the present disclosure.

FIG. 8 is an interface diagram illustrating example views of a user interface of the messaging system to facilitate an exchange of messages between users, according to various examples of the present disclosure.

FIG. 9 is a flowchart illustrating an example method for facilitating price negotiations using an AI negotiation agent, according to various examples of the present disclosure

FIG. 10 is a block diagram illustrating an ML pipeline, according to some example embodiments.

FIG. 11 is a data flow diagram illustrating training and use of an ML program, according to some example embodiments.

FIG. 12 is a block diagram illustrating a representative software architecture, which may be used in conjunction with various hardware architectures herein described, according to various examples of the present disclosure.

FIG. 13 is a block diagram illustrating components of a machine able to read instructions from a machine storage medium and perform any one or more of the methodologies discussed herein according to various examples of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details. Furthermore, well-known features may be omitted or simplified in order not to obscure the described embodiments.

As addressed above, users of e-commerce platforms often utilize the messaging systems of these platforms to engage in price manipulation techniques that degrade the functionality of these platforms. Sellers typically engage in these behaviors to maximize profits, drive quick purchasing decisions, gain competitive advantages, avoid price comparisons, and capitalize on buyer trust. Common price manipulation tactics employed by sellers include making false competitor comparisons, creating artificial urgency, exaggerating stock scarcity, misrepresenting price trends, and offering conditional discounts tied to immediate action. Similarly, buyers employ manipulative strategies to secure lower prices, leverage perceived competition, exploit seller vulnerabilities, avoid proper market research, maximize bargaining power, and obtain unjustified extras. Buyer price manipulation tactics often include making false claims about competitor prices, creating artificial urgency to close deals, threatening negative feedback, promising fake bulk orders, and exploiting return or refund policies.

As noted above, conventional e-commerce messaging systems lack effective technologies to detect and prevent this behavior. For example, these messaging systems lack automated validation mechanisms to verify pricing claims made during negotiations, allowing deceptive practices to proliferate unchecked. Current messaging systems typically operate with isolated data silos, where messaging functionality remains disconnected from marketplace pricing databases, transaction history, and user behavior metrics. This technical fragmentation prevents real-time cross-referencing of claims against actual market data, creating an environment where manipulative pricing tactics can thrive without detection.

These conventional messaging platforms often lack processing capabilities to analyze message intent or to identify manipulative language patterns in real-time communications. Thus, these systems cannot distinguish between legitimate negotiations and deceptive pricing tactics. Furthermore, conventional platforms lack the capabilities to verify claims about alternative pricing offers.

Current messaging systems also fail to incorporate historical data integration and behavioral monitoring mechanisms that could identify repeat offenders engaging in pricing manipulation. Additionally, these platforms have no automated intervention capabilities to prevent manipulative messages from reaching their intended recipients, allowing deceptive practices to continue unimpeded.

Beyond the forgoing deficiencies regarding price manipulation, conventional e-commerce platforms and their integrated messaging systems are generally deficient in facilitating price negotiation between users. For example, negotiations facilitated by e-commerce messaging systems traditionally lack data-driven insights and often fail to account for transactional data maintained by the platforms that reflect market conditions. Sellers often rely simply on intuition or fixed pricing strategies that fail to account for dynamic market conditions, competitor pricing, or individual buyer behavior. Without access to comprehensive data about market trends, inventory levels, or buyer preferences, sellers struggle to determine optimal pricing strategies that balance profitability with competitiveness. Similarly, buyers lack visibility into whether their offers are reasonable or competitive, frequently leading to unrealistic demands that sellers cannot accommodate.

Miscommunication further exacerbates these challenges. Ambiguities in messages, lack of clarity about terms such as discounts or shipping costs, and potential language barriers all contribute to misunderstandings that can derail otherwise promising negotiations. These communication issues not only frustrate both parties but can also erode trust in the platform itself.

Scalability presents an additional obstacle for users with high transaction volumes. As the number of concurrent negotiations increases, users find it increasingly difficult to manage all threads efficiently. Limited resources mean that some user inquiries receive delayed responses or insufficient attention, leading to dissatisfaction and missed opportunities. This scalability challenge becomes particularly acute during peak shopping periods when negotiation volumes surge.

The absence of transparency in pricing and negotiation outcomes further undermines trust between users of e-commerce platforms. Without structured negotiation frameworks, outcomes may appear arbitrary, leaving buyers questioning whether they received a fair deal and sellers uncertain about whether their pricing strategies are optimal. This lack of transparency discourages repeat interactions and diminishes overall platform engagement.

As noted above, existing solutions have attempted to address the challenges in facilitating price negotiations through basic automation tools or fixed pricing rules, but these approaches lack the technical sophistication needed to navigate the complex dynamics of buyer-seller negotiations.

Aspects of the present disclosure address the technical deficiencies of traditional online platform handling of price manipulation with systems, methods, techniques, instruction sequences, and computing machine program products that utilize a trained machine learning (ML) model such as a large-language model (LLM) to detect price manipulation attempts in messages exchanged between users of a messaging system of an online platform. In addition, a verification agent verifies whether messages classified as attempted price manipulation are properly classified and input from the verification agent can be used to retrain the ML model.

In an example, a messaging system facilitates electronic chat conversations (also referred to herein simply as “electronic conversations”) by allowing users to exchange messages that can include text, audio, images, and/or videos. The messaging system may be part of an online platform that further includes a review system that allows users to review goods and services as well as entities (e.g., businesses and individual sellers) that engage in transactions for the goods and services. The online platform may further include a publication system that allows users (e.g., sellers) to publish listings to offer the goods and services for sale. The messaging system receives a message from a first user to send to a second user as part of an electronic conversation between the users. The conversation pertains to one or more items (e.g., goods or services) offered for sale via a listing published by the publication system. That is, the first user may be a buyer of a good or service and the second user may be the seller of the good or service or vice versa. The messaging system generates contextual data (also referred to herein simply as “context”) for the message based on a chat history between the users, item listing data, transaction history of the first user, and user metrics of the first user. Based on the context, the messaging system classifies the message as attempted price manipulation using an ML model trained to classify the intent of messages. In an example, the message states, “Other sellers are charging $150 for this same item. My price of $130 is the best deal you'll find” when other sellers are offering the item for less than $130. In another example, the message states, “Another seller is offering the same product for $20 less. Can you match their price?” when there is no other seller offering the item for $20 less. Based on the message being classified as attempted price manipulation, the messaging system blocks the message from being sent to the second user and prevents the users from exchanging further messages.

A verification agent verifies whether the message is properly classified as attempted price manipulation based on communications with the first and second user. If the verification agent determines that the message was not properly classified as attempted price manipulation, the ML model is retrained based on input from the verification agent and the messaging system sends the message to the second user and allows the users to continue messaging. On the other hand, if the verification agent determines that the message is properly classified as attempted price manipulation, further messaging between the users continues to be blocked and the user metrics for the first user are updated to indicate that the first user engaged in attempted price manipulation, which is accounted for in an analysis of subsequent messages sent by the first user.

By utilizing an ML model trained to classify the intent of messages, the ability of the messaging system to detect and prevent attempted price manipulation is improved relative to traditional online messaging systems that completely lack this capability. Furthermore, the accuracy of the ML model in classifying messages as attempted price manipulation is improved through retraining when the ML model improperly classifies a message as attempted price manipulation, as determined by the verification agent. In addition, the utilization of the verification agent further improves the functioning of online messaging systems by providing a mechanism for users to continue messaging after a false positive classification of attempted price manipulation.

Aspects of the present disclosure also address the technical deficiencies of traditional online platform facilitating of price negotiation with systems, methods, techniques, instruction sequences, and computing machine program products that utilize an AI negotiation agent to facilitate price negotiation communications between users of an integrated messaging system. The AI negotiation agent integrates natural language processing, machine learning, and contextual data enrichment to facilitate price negotiations between users on e-commerce platforms. The agent processes messages using natural language processing to detect price negotiation intent, such as discount requests or counteroffers, and extracts relevant context from the conversation. To generate appropriate responses, the AI negotiation agent enriches the negotiation context with comprehensive data from multiple sources, including user profiles, inventory data, market trends, and platform policies. The AI negotiation agent also adapts responses in real-time based on message sentiment analysis and negotiation flow, adjusting suggestions and tone to maintain positive interactions while working toward deal closure. The machine learning models continuously improve through feedback loops that track successful patterns, buyer responses, and negotiation outcomes. When the AI negotiation agent detects the resolution of a price negotiation (e.g., an acceptance of a price offer or counteroffer), it automatically executes the transaction, including price adjustments and order confirmation transmission, increasing the efficiency of the negotiation-to-purchase process.

In an example, a messaging system of an online platform receives a message from a first user of a user device for sending to a second user. The message is received via a user interface of the user device of the first user. The message pertains to an item corresponding to an item listing published by a publication system of the online platform on behalf of the second user. That is, in this example, the second user is a seller of an item, and the first user is a potential buyer of the item. A first ML model trained to classify an intention of messages classifies the message as requested price negotiation. Based on the message being classified as requested price negotiation, the messaging system generates contextual data for the price negotiation for the item. Using a second ML model, the AI negotiation agent generates a response to the message based on the contextual data and the message is provided, via the user interface, to the first user on behalf of the second user as part of the price negotiation requested by the first user. One or more additional messages may be received from the first user, and the AI negotiation agent automatically generates and provides responses to the additional messages until a resolution of the price negotiation is reached. Based on detecting a resolution of the price negotiation, the AI price negotiation agent automatically executes a transaction for the item.

By enriching the negotiation context with comprehensive data from multiple sources—including user profiles, inventory data, market trends, and platform policies —the negotiation agent generates dynamically optimized responses that balance profitability for sellers with fairness for buyers. The adaptive response capabilities of the AI negotiation agent represent a significant technical advancement over conventional rule-based systems, as the machine learning models continuously improve through feedback loops that track successful patterns, buyer responses, and negotiation outcomes. Furthermore, the system architecture supports automated transaction execution upon detecting resolution, including price adjustments and order confirmation transmission, increasing the efficiency of the entire negotiation-to-purchase process while reducing the computational resource utilization required by conventional systems.

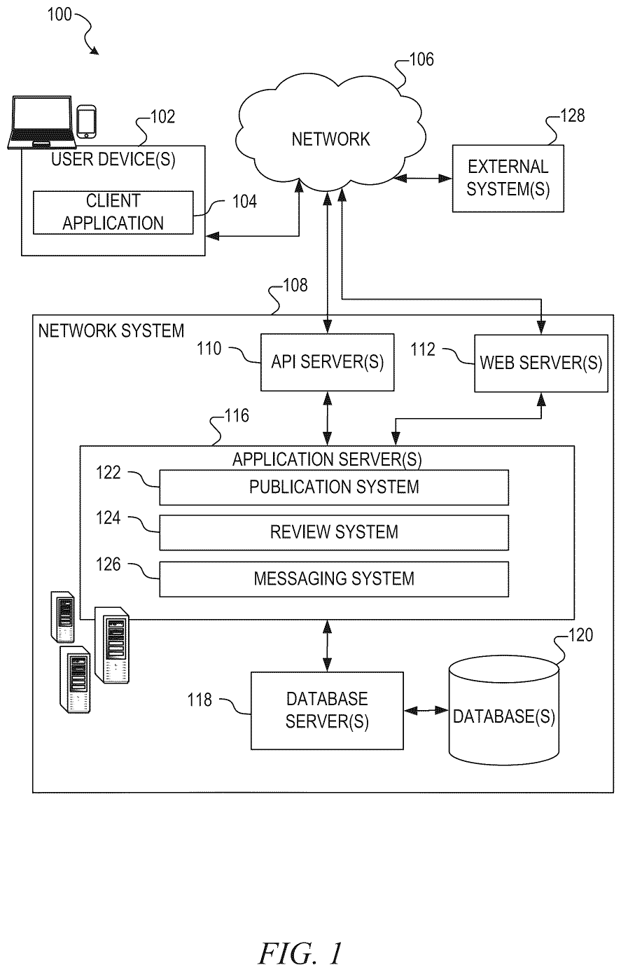

FIG. 1 is a block diagram showing an example network environment 100 that includes a messaging system 126, according to various examples of the present disclosure. As shown, the network environment 100 includes one or more user devices 102, a network system 108, and a network 106 (e.g., Internet, wide-area-network [WAN], local-area-network [LAN], wireless network) that communicatively couples them together. Each user device 102 can host a number of applications, including a client software application 104. The client software application 104 can communicate and exchange data with the network system 108 via a network 106.

The user device 102 may comprise but is not limited to, a smartphone, tablet, laptop, multi-processor systems, microprocessor-based or programmable consumer electronics, game consoles, or any other communication device that can access the network system 108. Additionally, each user device 102 comprises a display component (not shown) to display information (e.g., in the form of user interfaces) as will be discussed in more detail below.

The network system 108 provides server-side functionality via the network 106 to the client software application 104. While certain functionality is described herein as being performed by the messaging system 126 on the server system 108, it will be appreciated that the location of certain functionality within the network system 108 is a design choice. For example, it may be technically preferable to initially deploy certain technology and functionality within the network system 108, but to later migrate this technology and functionality to the client software application 104.

The network system 108 supports various services and operations that are provided to the client software application 104 by a publication system 122, a review system 124, and the messaging system 126. Further details regarding the various services and operations provided by the publication system 122, the review system 124, and the messaging system 126 are discussed below, but generally, these operations include: transmitting data from any one or more of the publication system 122, the review system 124, and the messaging system 126 to the client software application 104; receiving data from the client software application 104 at any one or more of the publication system 122, the review system 124, and the messaging system 126; and processing data generated by the client software application 104. Data exchanges within the network environment 100 may be invoked and controlled through operations of software component environments available via one or more endpoints, or functions available via one or more user interfaces of the client software application 104, which may include web-based user interfaces provided by the server system 108 for presentation at the user device 102.

With respect to the network system 108, one or more application programing interface (API) servers 110 and one or more web servers 112 are coupled to and provide programmatic and web interfaces respectively to one or more application servers 116. The application server(s) 116 host various systems including the publication system 122, the review system 124, and the messaging system 126, each of which comprises a plurality of components and each of which can be embodied as hardware, software, firmware, or any combination thereof. The application server(s) 116 are, in turn, coupled to one or more database servers 118 that facilitate access to one or more databases 120. The database(s) 120 may be stored in one or more storage devices and may, for example, include user accounts including user profiles of users of the network system 108 and can also store chat histories between users utilizing functionality of the messaging system 126.

The API server(s) 110 receives and transmits data (e.g., API calls, commands, requests, responses, and authentication data) between the user device(s) 102 and the application server 116. Specifically, the API server(s) 110 provides a set of interfaces (e.g., routines and protocols) that can be called or queried by the client software application 104 in order to invoke the functionality of the application server(s) 116. The API server(s) 110 expose various functions supported by the application server 116 including, without limitation, messaging, listing publication, and review of goods and services and sellers thereof.

The publication system 122 manages publications (e.g., articles, listings of available goods or services) and transactions (e.g., for goods and services) at the network system 108 including generating and publishing the publications, conducting searches for publications, and/or maintaining user accounts.

The review system 124 allows users to provide feedback on goods and services as well as on the sellers of the goods and services. Utilizing the review system 124, users can rate goods, services, and sellers thereof on various aspects such as quality, shipping speed, and customer service, providing a comprehensive evaluation. The review system 124 may aggregate and analyze review data to present summary statistics and trends to users.

The messaging system 126 facilitates electronic chat conversations between users by allowing them to exchange messages that include text, audio, images, and/or videos. The messaging system 126 utilizes an ML model to analyze and classify messages. In some examples, the ML model may classify a message as attempted price manipulation, and in response to the message being classified as attempted price manipulation, the messaging system 126 prevents the message from being sent and prevents further messaging in the electronic conversation in which the message is to be sent. The messaging system 126 further employs verification agents to verify whether messages are properly classified as attempted price manipulation, and if the verification agent determines that a message is not properly classified, the message is sent, further messaging is allowed, and the ML model is retrained. Further details regarding the messaging system 126 are discussed below.

In some examples, the ML model may classify messages as requested price negotiation, and in response, an AI negotiation agent of the messaging system 126 generates responses to the messages to facilitate the price negotiation based on various types of data obtained from the databases 120. Further details regarding the messaging system 126 are discussed below.

The environment 100 can also comprise one or more external systems 128. The external system(s) 128 can be a third-party system that performs data operations or processing for the network system 108. For example, the external system(s) 128 can comprise a large language model (LLM) or generative artificial intelligence (AI) system that processes data on behalf of the network system 108. The LLM is a trained model configured to generate text and perform natural language processing tasks such as classifying an intent of messages and/or generating responses to messages.

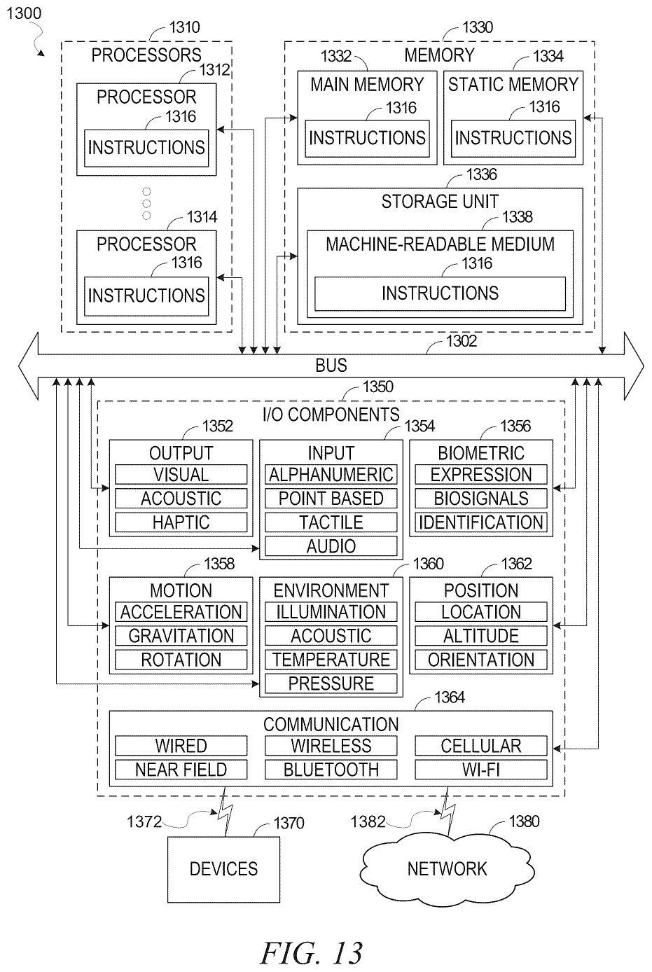

Any of the systems, data storage, or devices (collectively referred to as “components”) shown in, or associated with, FIG. 1 may be, include, or otherwise be implemented in a special-purpose (e.g., specialized or otherwise non-generic) computer that can be modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIG. 13, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined, and the functions described herein for any single component may be subdivided among multiple components. Functionalities of one system may, in alternative examples, be embodied in a different system. For example, any of the functionalities discusses above with respect to the messaging system 126 may be embodied within the user device 102, the publication system 122, or the review system 124. While only a single network system 108 is shown, alternatively, more than one network system 108 can be included (e.g., localized to a particular region).

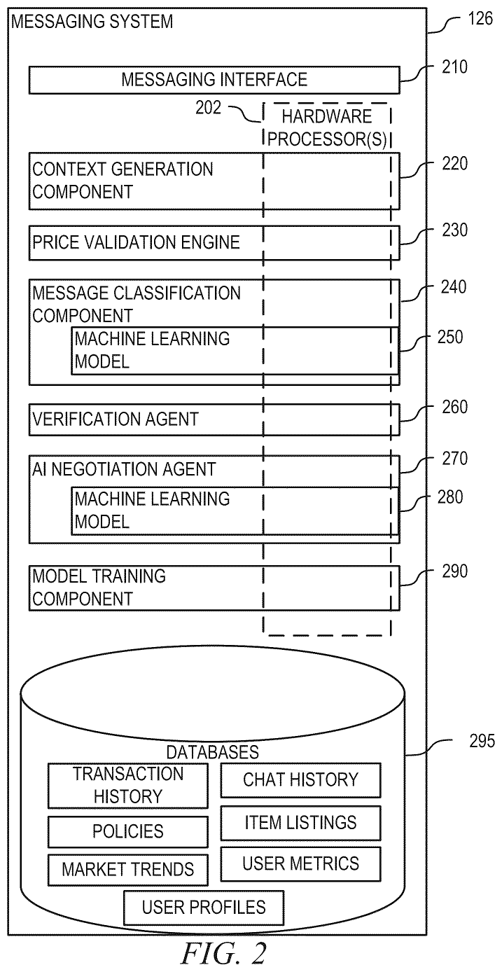

FIG. 2 is a block diagram illustrating components of the messaging system 126 of FIG. 1, according to various examples of the present disclosure. As shown, the messaging system 126 comprises a messaging interface 210, a context generation component 220, a price validation engine 230, a message classification component 240, a first ML model 250, a verification agent 260, an AI negotiation agent 270 (also referred to simply as “negotiation agent 270”), a second ML model 280, a model training component 290, and databases 295. According to various examples, any one or more of the context generation component 220, the price validation engine 230, the message classification component 240, the first ML model 250, the model training component 290, and the verification agent 260 can be implemented by one or more hardware processors 202.

The messaging interface 210 facilitates communications between users by allowing users to exchange messages in the context of one or more electronic conversations. Messages exchanged between users can include any one or more of text, audio, an image, or a video. The messaging interface 210 can be displayed by any one of the user devices 102 of FIG. 1 based, for example, on machine-readable instructions provided by the messaging system 126 to a client application 104 of FIG. 1.

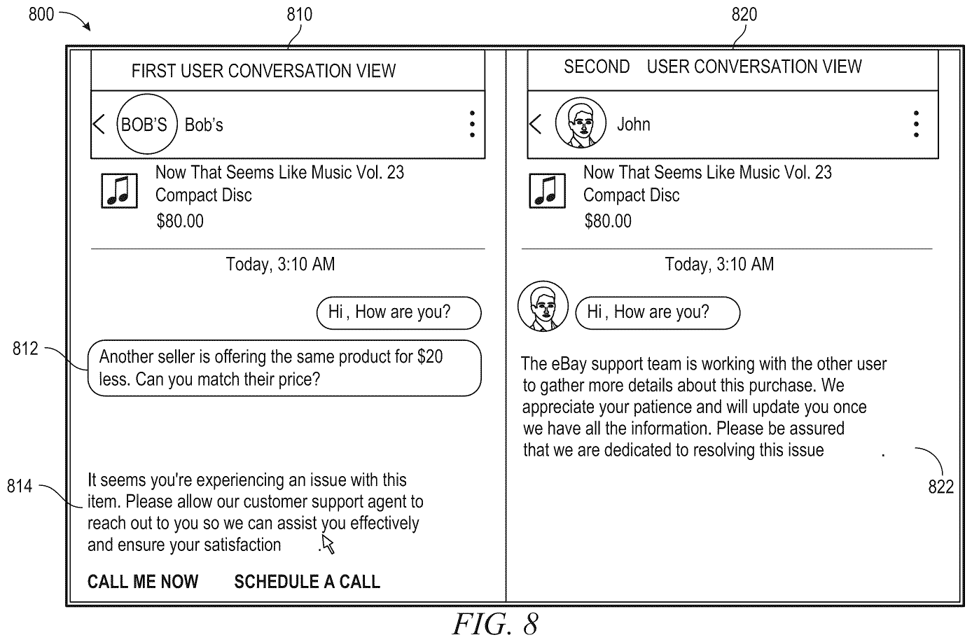

The messaging interface 210 may include multiple views such as a conversation view. As used herein, a “view” is a component of a user interface that includes an output representation of information in a particular format. Each of the multiple views may provide or enable different functionality with respect to the messaging system 126. As noted above, the messaging interface 210 includes the conversation view that allows users to author, send, and view messages exchanged as part of an electronic conversation between users. The conversation view includes graphical representations of each participating user (e.g., an image of the user) and one or more messages exchanged between participating users. Example conversation views of the messaging interface 210 are illustrated in FIG. 8 and described below.

The context generation component 220 is responsible for generating context (also referred to as “contextual data” herein) for messages for subsequent analysis and classification. As an example, to generate context for a given message exchanged between two users in an electronic conversation, the context generation component 220 accesses one or more chat histories from the databases 295 and extracts one or more previously exchanged messages between the two users that can be used to fully understand and assess the message. The context generation component 220 can extract messages from the current conversation between the two users and/or one or more previous conversations.

In addition to chat histories, in some examples, the context generation component 220 can generate context for messages based on any one or more: item listing data, transaction histories, and or user metrics, which the context generation component 220 accesses from the databases 295.

The context generation component 220 can also generate context for messages based on price validation data generated by the price validation engine 230. Price validation data indicates whether a price for an item satisfies a competitive price constraint such as an average price or a range of prices. The price validation engine 230 determines competitive price constraints for items based on an analysis of item listing data accessed from the databases 295. Consistent with some examples, the price validation engine 230 determines whether a price for an item satisfies a competitive price constraint depending on whether the price exceeds an average price or whether the price falls in the range of prices for the item. In generating the price validation data, the price validation engine 230 can also determine average shipping costs or shipping cost ranges, demand metrics indicating item demand, and availability metrics showing item availability. The validation process performed by the price validation engine 230 helps verify claims made in messages about competitor pricing, creating context that enables the message classification component 240 to identify potential price manipulation in communications.

The message classification component 240 is responsible for classifying an intent of messages exchanged between users of the messaging system 126. The message classification component 240 utilizes the first ML model 250 (e.g., a large language model [LLM]) to analyze the content and context for the message provided by the context generation component 220 for each received message and classify its intent into one or more predefined classifications. For example, utilizing the first ML model 250, the message classification component 240 can classify a message as attempted price manipulation. As shown in the example of FIG. 2, the first ML model 250 forms part of the message classification component 240, though in other examples, the first ML model 250 may be an independent component of the messaging system 126. In some examples, the message classification component 240 may encode the content of the message (e.g., text, audio, or video) and its context into a format suitable for processing by the first ML model 250 prior to processing by the first ML model 250.

In instances in which the message classification component 240 classifies a message as attempted price manipulation, the messaging system 126 blocks the message from being sent to the intended recipient user and blocks further messages from being exchanged in the conversation, pending further processing by the verification agent 260. That is, the messaging system 126 prevents the message from being displayed in a conversation view of the messaging interface 210 of the recipient user and prohibits both the recipient user and the sending user from using the conversation view to author further messages in the conversation, at least until the verification agent 260 verifies the message is properly classified as attempted price manipulation.

The verification agent 260 is responsible for verifying the classification of messages. For example, a verification agent 260 can verify whether a message was properly classified as attempted price manipulation. In the example illustrated by FIG. 2, the verification agent 260 is a machine-implemented agent, though in other examples, the verification agent 260 is a human agent. Consistent with the example illustrated by FIG. 2, the verification agent 260 comprises a machine-implemented agent, such as a chatbot, that includes an artificial intelligence (AI) powered software system configured to interact with users through natural language processing and generation.

In an example, the verification agent 260 verifies a message is properly classified as attempted price manipulation by communicating with the sending user and communicating with the recipient user. The verification agent 260 determines, based on the communications with the two users whether the message is properly classified as attempted price manipulation. If the verification agent 260 determines a message is improperly classified as attempted price manipulation, the messaging system 126 allows the message to be sent to the recipient user and once again allows the users to exchange message. Otherwise, the messaging system 126 continues to block the message from being sent and continues to prevent messages being exchanged between the two users.

The AI negotiation agent 270 facilitates price negotiation communications between users of the messaging system 126. The AI negotiation agent 270 works in conjunction with the message classification component 240 to process messages using natural language processing to detect price negotiation intent, such as discount requests or counteroffers. Utilizing the second ML model 280, the AI negotiation agent 270 generates appropriate responses by enriching the negotiation context with comprehensive contextual data generated by the context generation component 220 from data from the databases 295, including user profiles, inventory data, market trends, and platform policies. The AI negotiation agent 270 also uses the second ML model 280 to adapt responses in real-time based on message sentiment analysis and negotiation flow, adjusting initial suggestions to maintain positive interactions while working toward deal closure. When the AI negotiation agent 270 detects the resolution of a price negotiation, such as an acceptance of a price offer or counteroffer, the AI negotiation agent 270 automatically executes the transaction, including performing appropriate price adjustments based on price negotiations, term adjustments (e.g., free shipping), and automatic transmission of order confirmation.

As referenced above, the second ML model 280 is a trained model that the AI negotiation agent 270 utilizes to generate responses to messages based on contextual data generated by the context generation component 220. The second ML model 280 continuously improves through feedback loops that track successful patterns, buyer responses, and negotiation outcomes.

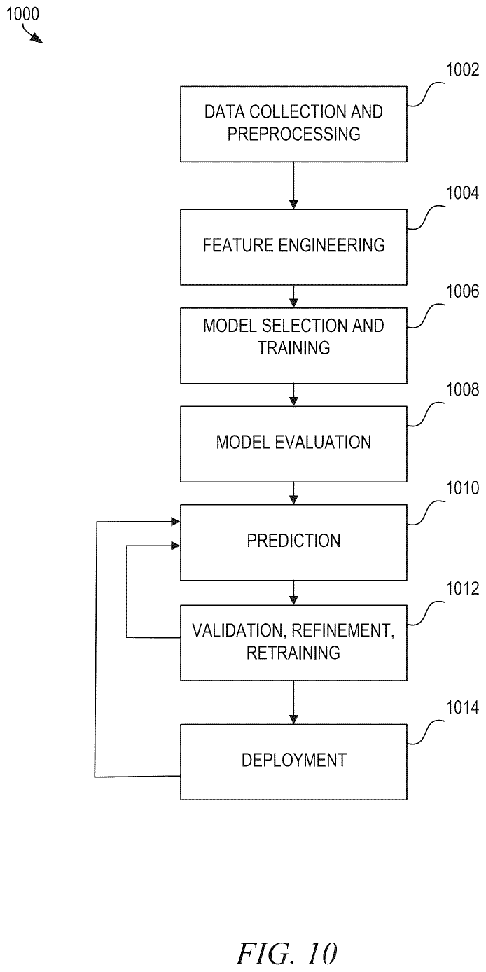

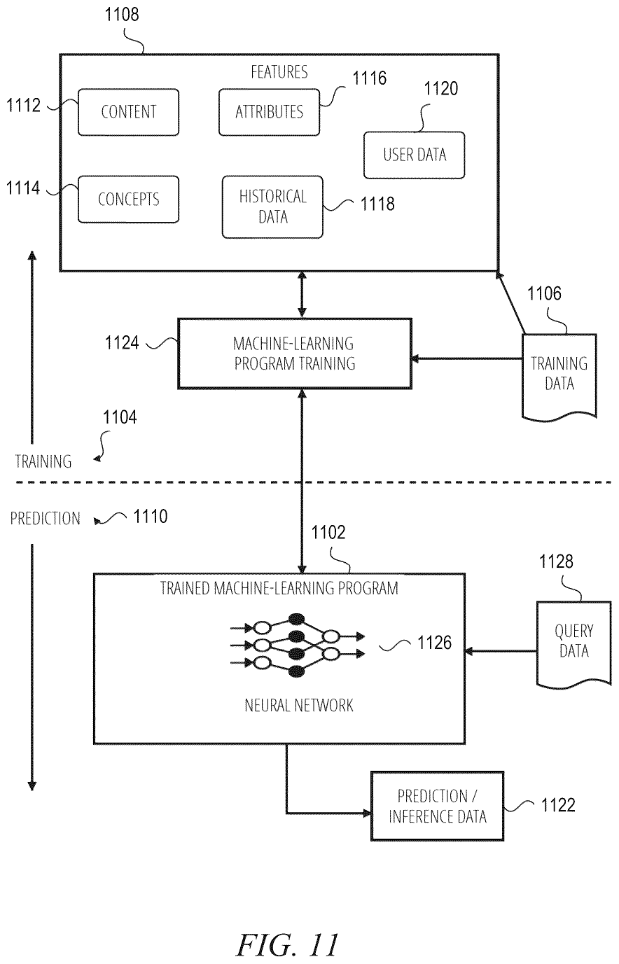

The model training component 290 is configured to train and retrain the ML models 250 and 280. In some examples, the model training component 290 trains the first ML model 250 on a corpus of labeled message data (e.g., labeled according to the corresponding intent of messages) and the model training component 290 retrains the first ML model 250 based on input from the verification agent 260. In some examples, the model training component 290 trains the second ML model 280 on a corpus of labeled message data (e.g., labeled according to negotiation outcomes) and the model training component 290 retrains the second ML model 280 based on messages received in response to responses generated by the second ML model 280 and outcomes of price negotiations facilitated by the AI negotiation agent 270. Further details regarding an ML pipeline and training and use of an example ML model are discussed below in reference to FIG. 10 and FIG. 11.

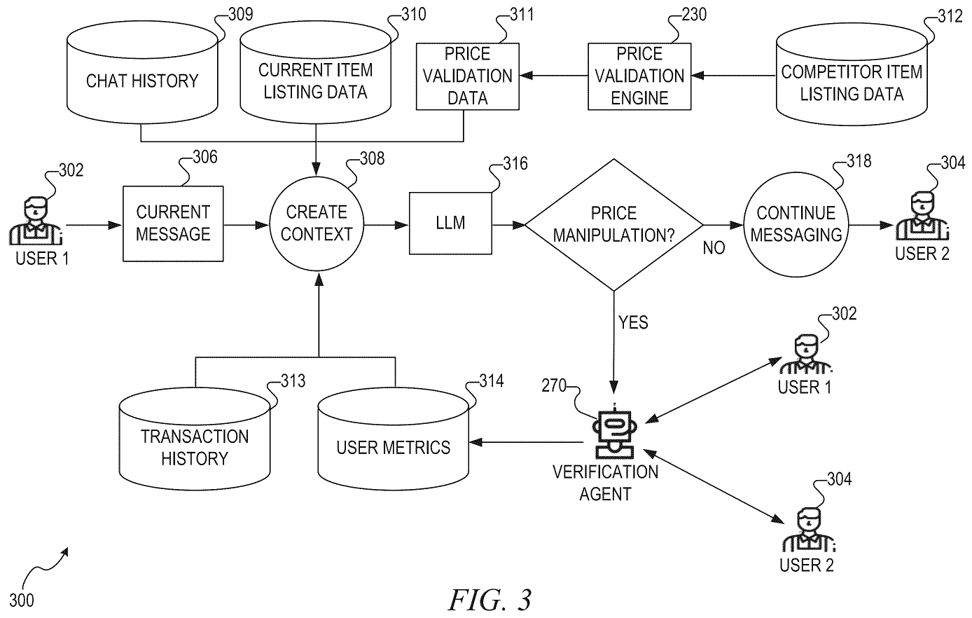

FIG. 3 is a data flow diagram illustrating a flow of operations in an example ML-based process 300 for detecting and handling attempted price manipulation in messages exchanged between users of the messaging system 126, according to various examples of the present disclosure. In the context of FIG. 3, a first user 302 (also referenced in FIG. 3 as “USER 1”) using a first user device and a second user 304 (also referenced in FIG. 3 as “USER 2”) using a second user device are engaged in an electronic conversation in which messages are being exchanged between the users (e.g., messages are sent to and from respective user devices).

As shown, a current message 306 from the first user 302 for sending to the second user 304 is received by the messaging system 126 (e.g., received from the first user device). The message pertains to an item corresponding to an item listing published by the publication system 122. In a first example, the first user is a seller of the item and the second user is a potential buyer. In a second example, the second user is a seller of the item and the first user is a potential buyer.

The context generation component 220 creates context for the current message 306, at operation 308, based on a chat history 309 between the first user 302 and the second user 304, current item listing data 310, price validation data 311, a transaction history 313 of the first user 302, and user metrics 314 of the first user 302. The chat history 309 includes at least one or more previous messages exchanged between the first user 302 and the second user 304 as part of the current conversation and may further include one or more previous messages from one or more previous conversations. The current item listing data 310 includes at least a listed price of the item and an available quantity of the item.

The price validation data 311 is generated by the price validation engine 230 based on competitor item listing data 312. The competitor item listing data 312 includes information about other listings for the item published by the publication system 122 or external systems. The competitor item listing data 312 includes one or more prices and one or more available quantities of the item corresponding to the other listings for the item. The generation of the price validation data includes accessing item listing data comprising information about one or more other item listings for the item published by the publication platform on behalf of other users. The information about the one or more other item listings comprises at least one price and at least one quantity for the item included in at least one other item listing for the item. The price validation data 311 comprises an indication of whether a price for the item satisfies a competitive pricing constraint such as an average price or a range of prices for the item as determined by an analysis of the competitor item listing data 312. The price for the item may be a price mentioned in the current message 306, a previous message exchanged between the user 302 and 304, or a price indicated by the current item listing data 310. In examples where the competitive pricing constraint is an average price for the item, the price validation engine 230 determines whether the price for the item (e.g., a price referenced in the message) satisfies the competitive pricing constraint by determining whether the price exceeds the average price for the item. In examples where the competitive pricing constraint is a range of prices for the item, the price validation engine 230 determines whether the price for the item (e.g., a price referenced in the message) satisfies the competitive pricing constraint determining whether the price is within the range of prices for the item. In some examples, the price validation engine 230 further accounts for shipping costs in determining the competitive pricing constraint while in other examples, the price validation engine 230 calculates and provides a separate shipping pricing constraint as part of the price validation engine 230. Consistent with some examples, the price validation data 311 further includes a demand metric for the item that indicates a demand for the item and/or an availability metric for the item that indicates an availability of the item based on the competitor item listing data 312.

The transaction history 313 comprises records of transactions in which the first user is a participant (e.g., as a buyer or seller) and includes disputes, returns, and cancelations. The user metrics 314 include past user behavior (e.g., in relation to the publication system 122, the messaging system 126, and/or the review system 124) and one or more reputation metrics (e.g., user feedback, user ratings, transaction defect rate, late shipment rate, and valid tracking rate.). The past user behavior may include one or more previous instances of messages created and/or transmitted by the first user being classified as attempted price manipulation. In some examples, the user metrics 314 includes a user score and/or one or more metric sub-scores for metrics that are used to determine the user score. In some examples, the context generation component 220 generates a user score based on the user metrics 314 and/or the transaction history 313 as part of generating the context for the current message 306, at operation 308.

Utilizing the first ML model 250, in the example form of an LLM 316, the message classification component 240 classifies an intent of the current message 306 based on the content of the message and the context for the message generated by the context generation component 220. If the message classification component 240 classifies the intent of the current message 306 as something other than attempted price manipulation, the messaging system 126 allows the users to continue messaging, at operation 318, and the message is sent to the second user 304 (e.g., sent to a second user device of the second user 304). On the other hand, if the current message 306 is classified as attempted price manipulation, the current message 306 is not sent to the second user 304 and the current message 306 is instead provided to the verification agent 260 to verify that the current message 306 is properly classified as attempted price manipulation. Though the current message 306 is not sent to the second user 304, in some examples, the current message 306 is displayed in a conversation view (e.g., of the messaging interface 210) of the first user 302 and stored in the chat history (e.g., one of the chat histories stored in the databases 295) of the first user 302.

To verify the classification of the current message 306, the verification agent 260 communicates with the first user 302 and/or further communicates with the second user 304 to determine additional information that can be used to determine whether the current message 306 is attempted price manipulation. In communication with the users, the verification agent 260 exchanges one or more messages with the users. In some instances, the verification agent 260 may follow up with additional communications with one or both of the two users based on communications with the other user. If the verification agent 260 determines that the current message 306 has been improperly classified as attempted price manipulation, the current message 306 is sent to the second user 304, the users are allowed to continue messaging, and the LLM 316 is retrained. If the verification agent 260 verifies the current message 306 was properly classified, the current message 306 is never sent to the second user 304, the users are not allowed to continue messaging, and the user metrics 314 for the first user 302 are updated to indicate that the first user 302 engaged in attempted price manipulation in relation to the current message 306. In some examples, further action may be taken with respect to the first user 302 such as blocking the first user 302 from using the messaging system 126 or providing reduced functionality to the first user 302.

The process 300 described above may be repeated for each new message received as part of the conversation between the user 302 and the user 304. That is, a first message may be received, classified as something other than attempted price manipulation, and messages classified as something other than attempted price manipulation may continue to be exchanged between the users until a message is received that is classified as attempted price manipulation.

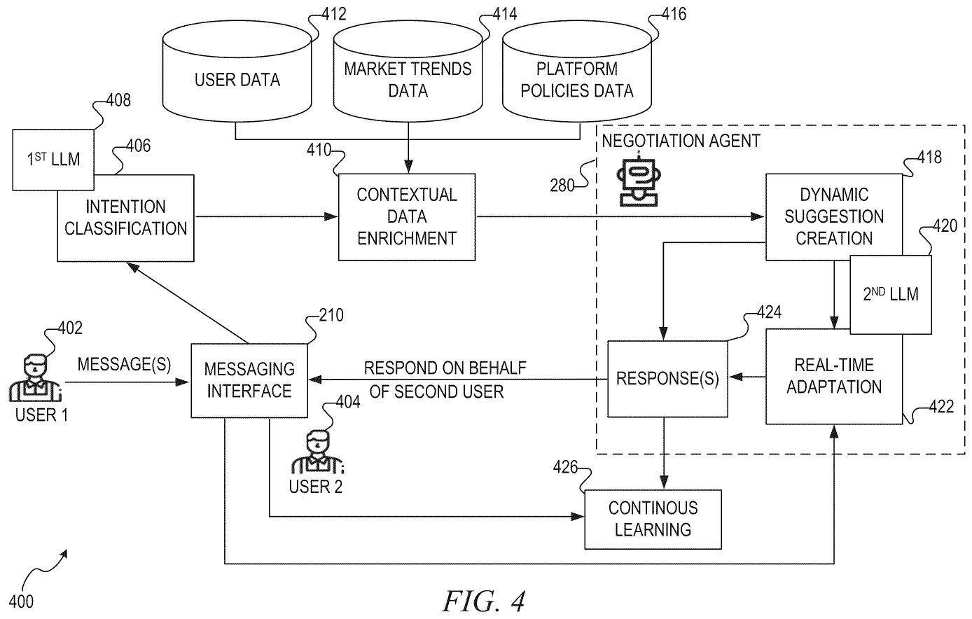

FIG. 4 is a data flow diagram illustrating a flow of operations in an example process 400 for facilitating price negotiation using an AI negotiation agent, according to various examples of the present disclosure. In the context of FIG. 4, a first user 402 (also referenced in FIG. 4 as “USER 1”) using a first user device is attempting to engage in an electronic conversation in which messages are being exchanged with a second user regarding an item listing published by the publication system 124 on behalf of the second user 404. In the example of FIG. 4., the second user 404 is a seller of the item and the first user 402 is a potential buyer of the item. The listing includes a list price for the item and one or more list terms (e.g., defining shipping costs).

Utilizing the first ML model 250, in the example form of an LLM 408, the message classification component 240 performs intention classification 406 on the messages exchanged between the first user 402 and the second user 404 based at least on the content of the messages. More specifically, in this example, the message classification component 240 performs intention classification to determine whether a given message from the first user 402 is a request for price negotiation for the item. The message classification component 240 may perform natural language processing on the messages to facilitate intention classification 406.

Based on a message being classified as a request for price negotiation, the context generation component 220 performs contextual data enrichment 410 by obtaining and combining various types of data from databases 295 including user data 412, market trends data 414, and platform policies data 416 with the content of the message. The user data 412 includes information about the first user 402 (buyer data) and the second user 404 (seller data). The information about the first user 402 (buyer data) includes a purchase history (e.g., products purchased, price ranges, and frequency), preferences (e.g., saved items, wish lists, and browsing patterns), negotiation patterns (e.g., typical discount requests, willingness to compromise, and response time), and engagement levels. The information about the second user 404 (seller data) includes inventory levels (e.g., current stock for each item), pricing history (e.g., historical pricing trends, previous discounts), profit margins, minimum acceptable price thresholds, and negotiation outcomes. The market trends data 414 comprises pricing information (e.g., real-time prices for similar items), demand fluctuations (e.g., spikes during holidays or social media trends), seasonality patterns (periods of higher demand for specific products), and real-time market dynamics that influence both buyer purchasing behaviors and seller pricing strategies (e.g., current supply and demand conditions). The platform policies data 416 comprises return policies (e.g., conditions for product returns, timelines, and restocking fees), shipping terms (e.g., costs, delivery timelines, and regions served), discount limits (e.g., maximum allowable discounts), and eligibility conditions that govern both buyer purchasing decisions and seller operational boundaries.

The negotiation agent 270 uses the second ML model 280 in the example form of a second LLM 420 to generate responses to messages received from the first user 402 on behalf of the second user 404. As an example, the negotiation agent 270 performs dynamic suggestion creation 418 using the second LLM 420. The dynamic suggestion creation 418 involves evaluating the contextual data to generate optimized suggestions for responding to messages exchanged in furtherance of the price negotiation. The negotiation agent 270 generates suggestions that balance profitability for sellers (e.g., the second user 404) with fairness for buyers (e.g., the first user 402).

In some instances, to generate a response to a message from the first user 402, the negotiation agent 270 may further perform real-time adaptation 422 of an initial suggestion using the second LLM 420. The real-time adaptation 422 involves adjusting suggestions dynamically based on the negotiation flow. For example, if the first user 402 declines an offer, the negotiation agent 270 modifies a counteroffer while considering seller limits.

In some examples, the real-time adaptation 422 includes performing sentiment analysis on messages to detect urgency (e.g., “I need this immediately!”), frustration (e.g., “This is disappointing!”), and/or dissatisfaction (e.g., “I'm not sure about that price”) and determine empathetic responses, which may be generated by modifying one or more suggested responses. In a first example, the negotiation agent 270 detects frustration in a message from the first user 402 based on sentiment analysis, and the negotiation agent 270 generates a response that acknowledges concerns while offering constructive solution such as “We value your feedback. Let's find a deal that works for you.” In a second example, the negotiation agent 270 detects urgency in a message from the first user 402 and generates a response that highlights expedited shipping options. In a third example, negotiation agent 270 detects satisfaction in a message from the first user 402 and generates a response that emphasizes positive aspects of the deal while potentially introducing complementary items. In this way, the real-time adaptation 422 enables the negotiation agent 270 to maintain positive interactions while working toward deal closure.

Based on one or more of the dynamic suggestion creation 418 and the real-time adaptation 422, the negotiation agent 270 generates response(s) 424 to messages from the first user 402. In a first example, the negotiation agent 270 generates a suggestion for responding to a message from the first user 402 based on the content of the message and the context and the negotiation agent 270 provides the suggestion as the response 424 to the first user 402. In a second example, the negotiation agent 270 generates an initial suggestion for responding to a message from the first user 402 based on the content of the message and the context (dynamic suggestion creation 418) and the negotiation agent 270 refines the initial suggestion based on the context, one or more previous messages exchanged between the first user 402 and the second user 404, and/or a sentiment or tone determined based on sentiment analysis of the message and/or the previous messages.

The response(s) 424 can include an offer or counteroffer for the item based on an adjustment to the list price and/or an adjustment to list terms. In some examples, the response(s) 424 generated by the negotiation agent 270 also includes an explanation of the rationale behind each response to enhance trust by showing how decisions are data-driven and fair. As an example, a response generated by the negotiation agent 270 may include an offer along with the following statement “This offer reflects current stock levels and aligns with competitor pricing.”

In some examples, in generating response(s) 424, the negotiation agent 270 identifies one or more complementary items based on the user profile data for the first user 402 and the inventory data of the second user 404, and the negotiation agent 270 bundles the one or more complementary items with one or more incentives such as discounts or free shipping as part of an offer included in a response 424. In an example, the item is a phone, the negotiation agent 270 identifies a screen protector as a complementary item, and the negotiation agent 270 generates a response 424 that includes an offer for the combination of the phone and screen protector at a discount relative to the list price for the phone and the list price for the screen protector.

The response(s) 424 are provided to the first user 402 on behalf of the second user 404 via the messaging interface 210. That is, the response(s) 424 are presented to the first user 402 in a conversation view of the messaging interface 210 in a manner that makes it appear that the response(s) 424 were sent by the second user 404. The process continues until the negotiation agent 270 detects a resolution of the price negotiation (e.g., based on the content of one or more messages received from the first user 402). For example, the negotiation agent 270 may detect an acceptance by the first user 402 of an offer made on behalf of the second user 404 by the negotiation agent 270 as part of a response 424. Upon detecting the resolution of the price negotiation, the AI negotiation agent 270 automatically executes a transaction for the item between the first user 402 and the second user 404. In doing so, the AI negotiation agent 270 may adjust a price of the item relative to a list price, adjust one or more terms of the transactions relative to the terms defined by the listing (e.g., free shipping), transmitting an order confirmation to one or more of the first user 402 and the second user 404, and/or automatically facilitating payment.

The model training component 290 facilitates continuous learning 426 to improve the second LLM 420. Continuous learning 426 involves learning from completed negotiations to improve future interactions. Continuous Learning 426 includes tracking successful patterns, buyer responses, and negotiation outcomes. The model training component 290 updates pricing models and negotiation strategies based on the tracked data. Continuous learning 426 enables the second LLM 420 to adapt to changing market conditions and user behaviors, improving the effectiveness of the negotiation agent 270 over time.

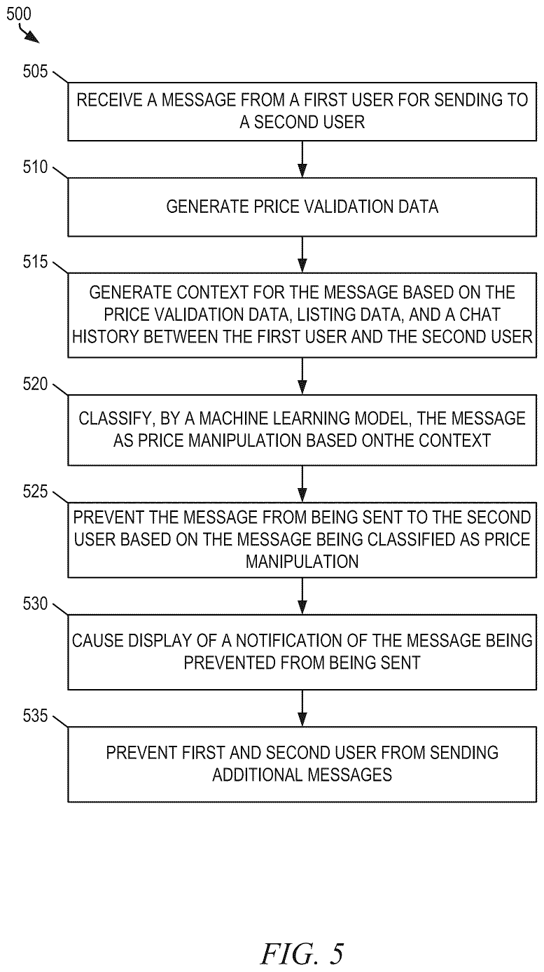

FIGS. 5-7 are flowcharts illustrating an example method 500 for detecting and handling attempted price manipulation in messages exchanged between users of the messaging system, according to various examples of the present disclosure. It will be understood that example methods described herein may be performed by a machine in accordance with some examples. For example, method 500 can be performed by the messaging system 126 described with respect to FIG. 1 and FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 500 may be represented by executable instructions that, when executed by a processor of a computing device, cause the computing device to perform method 500. Accordingly, the operations of the method 500 are described below in reference to such a computing device.

Depending on the embodiment, an operation of an example method described herein may be repeated in different ways or involve intervening operations not shown. Though the operations of example methods may be depicted and described in a certain order, the order in which the operations are performed may vary among examples, including performing certain operations in parallel.

At operation 505, a computing device receives a message from a first user device (e.g., one of the user devices 102) of a first user for sending to a second device (e.g., another one of the user devices 102) of a second user. The message pertains to an item corresponding to an item listing published by a publication platform (e.g., the publication system 122). In a first example, the first user is a potential buyer, the second user is a seller, and the message pertains to an item offered for sale by the second user. In a second example, the first user is a seller, the second user is a potential buyer, and the message pertains to an item offered for sale by the first user.

The message can comprise any one or more of text, audio, an image, or a video. The message may be one of multiple messages exchanged between the first user and the second user in the context of a conversation facilitated by a messaging system (e.g., the messaging system 126). To facilitate the conversation between the first and second user, the messaging system provides a messaging interface to the first and second device. The messaging interface includes a conversation view that displays messages exchanged between the first user and the second user. Example conversation views of a first user and second user from the messaging interface are illustrated in FIG. 8 and discussed below.

At operation 510, the computing device generates price validation data for the item to which the message pertains. The price validation data comprises an indication of whether a price for the item satisfies a competitive pricing constraint for the item. In some examples, the price is mentioned in the message or a previous message exchanged between the users. In some examples, the price is the listing price for the item.

In some examples, the generating of the price validation data includes accessing item listing data comprising information about one or more other item listings for the item published by the publication platform on behalf of other users. The information about the one or more other item listings comprising at least one price and at least one quantity for the item included in at least one other item listing for the item. The computing device determines the competitive pricing constraint for the item based on the item listing data and determines whether the competitive pricing constraint. The competitive pricing constraint comprises an average price for the item or a range of prices for the item. In examples where the competitive pricing constraint is an average price for the item, the computing device determines whether the price for the item (e.g., a price referenced in the message) satisfies the competitive pricing constraint by determining whether the price exceeds the average price for the item. In examples where the competitive pricing constraint is a range of prices for the item, the computing device determines whether the price for the item (e.g., a price referenced in the message) satisfies the competitive pricing constraint determining whether the price is within the range of prices for the item.

Consistent with some examples, the generating of the price validation data comprises any one or more of: determining average shipping costs or a range of shipping costs for the item based on the item listing data; determining a demand metric for the item, the demand metric indicating a demand for the item; or determining an availability metric for the item, the availability metric indicating an availability of the item based on the listing data.

At operation 515, the computing device generates context for the message based at least in part on the price validation data, listing data for the listing of the item to which the message pertains, and a chat history between the first user and the second user. The chat history comprises one or more messages previously exchanged between the first user and the second user at least in the conversation in which the message received at operation 505 was sent. The chat history may include one or more messages from previous conversations between the first user and the second user. The computing device accesses the chat history from a database of chat histories (e.g., from chat histories stored in the databases 295). In generating the context, the computing device parses the chat history and extracts one or more messages from the chat history that provide additional information that can be used to fully understand and assess the message received at operation 505. As will be discussed in further detail below, in some examples, the generating of the context further includes determining a user score of the first user.

At operation 520, the computing device uses an ML model (e.g., first ML model 250) to classify the intention of the message based on the message content and the context. More specifically, the ML model classifies the message as attempted price manipulation based on the context. The ML model is trained (e.g., by the model training component 290) to classify the intention of messages. Further details regarding ML model training are discussed below in reference to FIGS. 10 and 11.

At operation 525, the computing device prevents the message from being sent to the second device of the second user based on the message being classified as attempted price manipulation. In some examples, though the message is not sent to the second device of the second user, the message may be displayed in the conversation view of the first user presented by the messaging interface of the first device. Consistent with these examples, the message is stored in a chat history (e.g., one of the chat histories stored in the databases 295) of the first user so that the chat history of the first user is up to date.

At operation 530, the computing device causes display of a notification of the message being prevented from being sent on one or more of the first user device and the second user device. The notification may be displayed as part of a conversation view of the messaging interface provided to the first and second user device. An example of such a notification is illustrated in FIG. 8 and described below.

At operation 535, the computing device prevents the first and second user from sending additional messages based on the message being classified as attempted price manipulation.

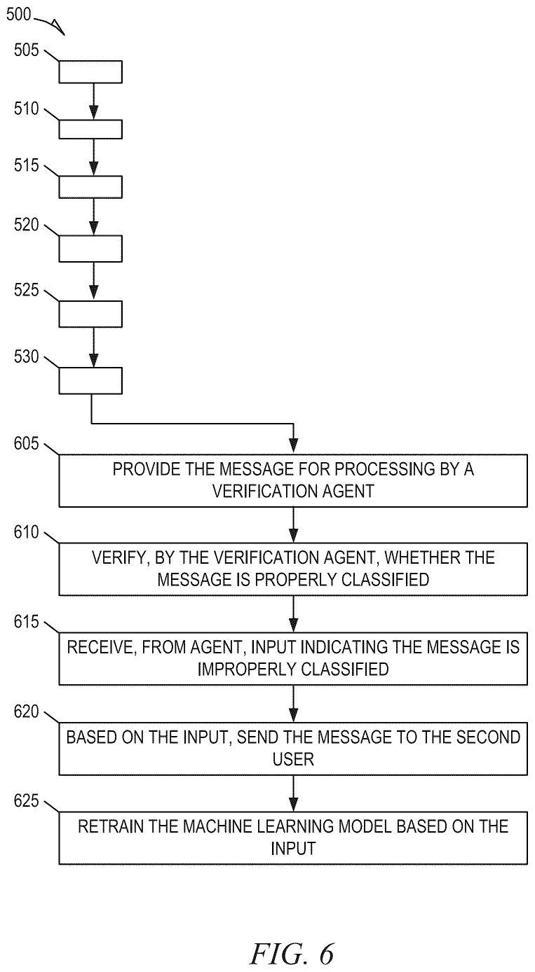

As shown in FIG. 6, the method 500 can, in some examples, include operations 605, 610, 615, 620, and 625. Consistent with some examples, operations 605, 610, 615, 620, and 625 are performed subsequent to the operation 530 where the computing device prevents the first and second users from sending additional messages based on the message being classified as attempted price manipulation.

At operation 605, the computing device provides the message for processing by a verification agent. The verification agent may be a human agent or a machine-implemented agent.

At operation 610, the verification agent verifies whether the message is properly classified as attempted price manipulation. In the example addressed by FIG. 6, the verification agent determines that the message is improperly classified as attempted price manipulation. In other examples, the verification agent verifies that the message is properly classified, and no further action is taken by the computing device. That is, the computing device continues to prevent the message from being sent to the second user and prevents the first user and the second user from exchanging any further messages.

In an example, the verification agent verifies whether the message is properly classified as attempted price manipulation by communicating with the first user regarding the message and communicating with the second user regarding the message to determine whether price manipulation is being attempted by the first user.

At operation 615, the computing device receives input from the verification agent indicating that the message is improperly classified. Based on the input received from the verification agent, the computing system sends the message to the second user and allows the first user and second user to continue to exchange messages, at operation 620. The computing device further retrains the ML model, at operation 625, based on the input to improve the ML model's ability to properly classify an intention of messages.

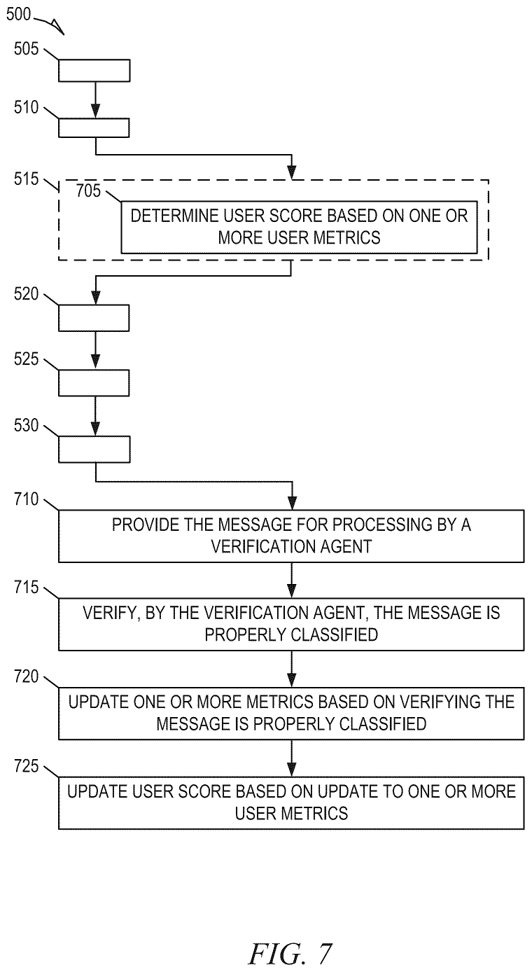

As shown in FIG. 7, the method 500 can, in some examples, include operations 705, 710, 715, 720, and 725. Consistent with these examples, the operation 705 may be performed prior to or as part of the operation 615 where the computing device generates the context for the message. At operation 705, the computing device determines a user score for the first user (the user who sent the message being analyzed) based on one or more user metrics. To determine the user score, the computing device may calculate the user score on the fly or may access a precalculated user score from a database (e.g., one of the databases 120).

The one or more user metrics used to determine the user score include one or more of: past user behavior in relation to the publication system, the messaging system, or an associated review system (e.g., the review system 124); one or more reputation metrics (e.g., user feedback, user ratings, transaction defect rate, late shipment rate, valid tracking rate, etc.); and a transaction history for the first user including disputes, returns, and cancellations. The past user behavior may include one or more previous instances of messages created and/or transmitted by the first user being classified as attempted price manipulation. In this way, the user score can provide an indication of the likelihood of the first user engaging in attempted price manipulation based on the past behavior of the first user.

In some examples, a sub-score is assigned or calculated for each user metric and the sub-scores are combined (e.g., summed) to determine the user score. A weighting factor may be applied to one or more of the sub-scores prior to or as part of the combining.

Consistent with some examples, operations 710, 715, 720, and 725 are performed subsequent to the operation 530 where the computing device prevents the first and second users from sending additional messages based on the message being classified as attempted price manipulation.

At operation 710, the computing device provides the message for processing by a verification agent (e.g., a human agent or a machine-implemented agent) and the verification agent verifies the message is properly classified as attempted price manipulation, at operation 715.

The computing device updates the one or more user metrics based on verifying that the message is properly classified as price manipulation at operation 720, and the computing device updates the user score based on the update to the one or more user metrics, at operation 725. In an example, the computing device updates one or more metric sub-scores based on verifying that the message is properly classified as price manipulation and the computing device updates the user score based on the updated one or more sub-scores.

FIG. 8 is an interface diagram illustrating example views of a user interface 800 of the messaging system to facilitate an exchange of messages between users, according to various examples of the present disclosure. More specifically, FIG. 8 illustrates a first user conversation view 810 and a second user conversation view 820. Both the first user conversation view 810 and the second user conversation view 820 display messages exchanged between a first user and a second user in the context of an electronic conversation. In the example illustrated by FIG. 8, the first user is a potential buyer in a transaction for an item (specifically “Now That Seems Like Music Vol. 23 Compact Disc”), the second user is the seller of the item, and the messages exchanged as part of the conversation pertain to the item.

As shown in the first user conversation view 810, the first user has attempted to send message 812 to the second user. However, the message 812 has been classified (e.g., by the message classification component 240) as attempted price manipulation. Accordingly, the messaging system 126 has prevented the message from being sent to the second user and thus the message 812 is not included in the conversation view 820, though it is displayed by the first user conversation view 810. In addition, the conversation view 810 includes a notification 814 that indicates that the message 812 is not being sent to the second user and allows the user to contact a verification agent to aid in the agent's verification of the classification of the message as attempted price manipulation. Similarly, the second user conversation view 820 includes a notification 822 that indicates an issue with the message from the first user.

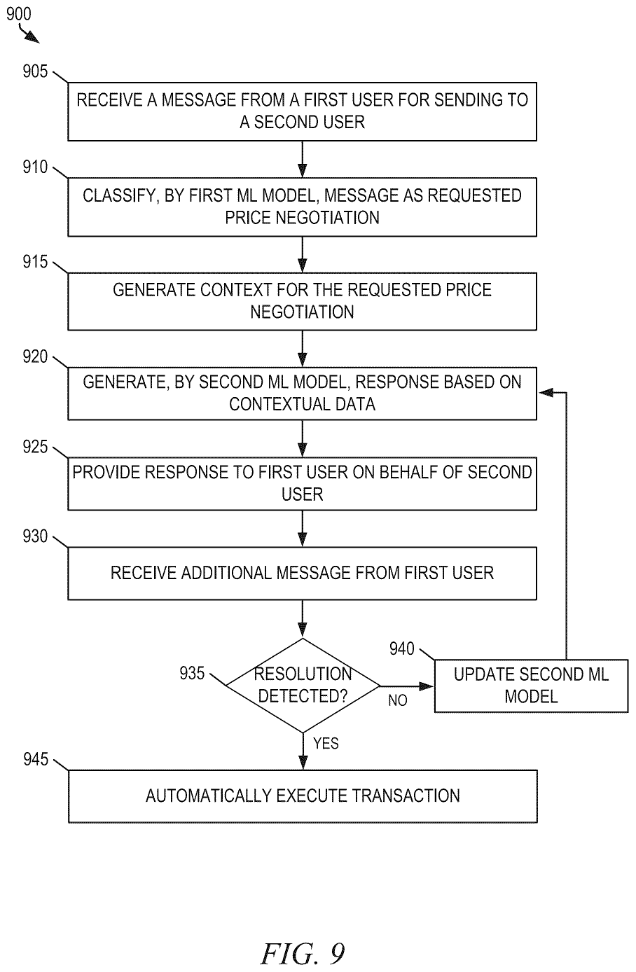

FIG. 9 is a flowchart illustrating an example method 900 for facilitating price negotiations using an AI negotiation agent 270, according to various examples of the present disclosure. It will be understood that example methods described herein may be performed by a machine in accordance with some examples. For example, method 900 can be performed by the messaging system 126 described with respect to FIG. 1 and FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 900 may be represented by executable instructions that, when executed by a processor of a computing device, cause the computing device to perform method 900. Accordingly, the operations of the method 900 are described below in reference to such a computing device.

Depending on the embodiment, an operation of an example method described herein may be repeated in different ways or involve intervening operations not shown. Though the operations of example methods may be depicted and described in a certain order, the order in which the operations are performed may vary among examples, including performing certain operations in parallel.

At operation 905, a computing device receives, via a user interface (e.g., messaging interface 210) presented by a first user device (e.g., one of the user devices 102), a message from a first user for sending to a second device (e.g., another one of the user devices 102) of a second user. The message pertains to an item corresponding to an item listing published by a publication platform (e.g., the publication system 122). In an example, the first user is a potential buyer, the second user is a seller, and the message pertains to an item offered for sale by the second user. The message can comprise any one or more of text, audio, an image, or a video. The message may be one of multiple messages exchanged between the first user and the second user in the context of a conversation facilitated by a messaging system (e.g., the messaging system 126). The user interface includes a conversation view that displays messages exchanged between the first user and the second user. Example conversation views of a first user and second user from the user interface are illustrated in FIG. 8 and discussed above.

At operation 910, the computing device classifies, using a first ML model (e.g., first ML model 250) trained to classify an intent of messages, the message as requested price negotiation for the item.

Based on the message being classified as requested price negotiation, the computing device generates context for the requested price negotiation, at operation 915. In generating the context, the computing device obtains and combines various types of data that include information that is relevant to the price negotiation. For example, the computing device may obtain any one or more (e.g., from the databases 295) of: user profile data of the first user and the second user; market trends data; and platform policies data. The user profile data includes both buyer data such as purchase history, preferences, negotiation patterns, and/or engagement levels, and seller data such as inventor levels, pricing history, profit margins, and minimum acceptable price thresholds. The market trends data comprises pricing information, demand fluctuations, seasonality patterns, and real-time market dynamics that influence both buyer purchasing behaviors and/or seller pricing strategies. The platform policies data comprises return policies, shipping terms, discount limits, and eligibility conditions that govern both buyer purchasing decisions and seller operational boundaries.

At operation 920, the computing device uses a second ML model (e.g., the second ML model 280) to generate a response to the message based on the contextual data. In some examples, the computing device uses the second ML model to generate an initial suggestion for responding to the message and the computing device uses the second ML model to refine the response to more suitably respond to the price negotiation request. The initial suggestion and/or the refinement of the initial suggestion may be further based on one or more previous messages exchanged between the first user and the second user.

In some examples, the generating of the response includes performing a sentiment analysis on one or more messages exchanged between the users to identify emotions like urgency, frustration, or satisfaction and the computing device tailors the response accordingly to maintain a positive interaction. Consistent with these examples, the computing device may generate an initial suggestion using the second ML model and refine the suggestion to account for a determined sentiment of the first user.

In some examples, the response generated by the computing device includes an offer or a counteroffer for the time based on an adjustment to the list price and/or list terms (e.g., shipping cost). In some examples, the response may further comprise an explanation of a rationale behind the offer or counteroffer to promote transparency and enhance trust with the first user.

In some examples, the response generated by the computing device may include or suggest a complementary item based on the user profile of the first user and inventory data for the second user. Thus, the response may comprise an identifier of the complementary item. The computing device may bundle one or more complementary items with incentives like discounts or free shipping as part of an offer or counteroffer included in the response. Thus, consistent with these examples, the generating of the response may include identifying one or more complementary items for the item based on the user profile of the first user and inventory data for the second user.

At operation 925, the computing device provides, via the user interface, the response to the first user on behalf of the second user. In some examples, the computing device responds automatically on behalf of the second user without any user intervention. In some examples, the computing device provides the response in response to the first user to receiving input from the second user indicative of an approval of the response.

The computing device receives, via the user interface, an additional message from the first user, at operation 930. At operation 935, the computing device determines whether the price negotiation has reached a resolution based on the additional message received from the first user. The computing device may utilize the first ML model to determine whether the additional message from the first user constitutes a resolution of the price negotiation.

As an example, the response provided to the first user may comprise an offer to sell the item for a certain price (e.g., a counter-offer based on a proposed price in the initial message received from the first user) and the additional message received from the first user may comprise an acceptance of the offer, which results in resolution of the price negotiation for the item. In another example, the response provided to the first user may comprise an offer to sell the item for a certain price and the additional message may comprise a counter-offer or other refusal of the offer, which does not result in a resolution of the price negotiation.

If the computing device does not detect a resolution of the price negotiation, the method 900 proceeds to operation 940 where the computing device updates (e.g., retrains) the ML model based on the additional message and then the method 900 returns to operation 920 where the computing device uses the second ML model to generate an additional response to the additional message. This process repeats until the computing device detects a resolution of the price negotiation (at operation 935) or until the method 900 is terminated based on a lack of further participation by the first user.

Based on detecting a resolution to the price negotiation, the computing device automatically executes a transaction for the item, at operation 945. To execute the transaction, the computing device adjusts a price of the item (e.g., based on an agreed-upon price arrived at via the price negotiation) relative to a price for the item indicated by the listing for the item, and transmits an order confirmation to the first user device. In some examples, the computing device may transfer an amount of value (e.g., monetary value) corresponding to the adjusted price from the first account of the first user to a second account of the second user or may otherwise automatically effectuate payment for the item using known payment processing techniques. In some examples, the computing device may further adjust one or more terms of the transaction relative to the terms defined by the listing (e.g., by making shipping free). In some examples, the computing device may further adjust one or more inventory levels of the second user based on the transaction.

Described implementations of the subject matter can include one or more features, alone or in combination, as illustrated below by way of example.

Example 1. A system comprising: one or more hardware processors; and a memory storing instructions that, when executed by the one or more processors, cause the one or more processors to perform operations comprising: receiving, via a user interface of a user device of a first user, a message from the first user for sending to a second user, the message pertaining to an item corresponding to an item listing; classifying, by a first machine learning model trained to classify an intention of messages, the message as requested price negotiation for the item; based on classifying the message as requested price negotiation, generating context for the requested price negotiation for the item; generating, by a second machine learning model, a response to the message based on the context; and providing, via the user interface of the user device, the response to the message to the first user on behalf of the second user.

Example 2. The system of Example 1, wherein the operations comprise: detecting, using the first machine learning model, a resolution to the price negotiation based on one or more messages exchanged between the first user and the second user subsequent to providing the response to the first user; and in response to detecting the resolution, automatically executing a transaction for the item between the first user and the second user.

Example 3. The system of any one or more of Examples 1 or 2, wherein automatically executing the transaction comprises: adjusting a price of the item; and transmitting an order confirmation to the user device.

Example 4. The system of any one or more of Examples 1-3, wherein: the message is a first message; the response is a second message; the operations comprise: receiving, via the user interface of the user device of the first user, a second message subsequent to providing the response to the first user; determining, using the first machine learning model, the second message does not comprise a resolution to the price negotiation; and in response to determining the second message does not comprise a resolution to the price negotiation, generating, using the second machine learning model, a second response to the second message.

Example 5. The system of any one or more of Examples 1-4, wherein the operations comprise updating the second machine learning model based on determining the second message does not comprise a resolution to the price negotiation.

Example 6. The system of any one or more of Examples 1-5, wherein the generating of context comprises obtaining and combining one or more of: user data, market trend data, and platform policy data, the user data including information about the first user and the second user, the information comprising one or more of: purchase history, user preferences, negotiation patterns, inventory levels, pricing history, and profit margins, the market trend data comprising competitor pricing data, demand fluctuation data, and seasonality data, the platform policy data comprising return policies, shipping terms, and discount limits.

Example 7. The system of any one or more of Examples 1-6, wherein the operations comprise performing sentiment analysis on the message, wherein the generating of the response is further based on a result of the sentiment analysis.

Example 8. The system of any one or more of Examples 1-7, wherein the generating of the message comprises identifying a complementary item associated with the item, wherein the messages comprises an identifier of the complementary item.

Example 9. A method comprising: receiving, via a user interface of a user device of a first user, a message from the first user for sending to a second user, the message pertaining to an item corresponding to an item listing; classifying, by a first machine learning model trained to classify an intention of messages, the message as requested price negotiation for the item; based on classifying the message as requested price negotiation, generating, by at least one hardware processor, context for the requested price negotiation for the item; generating, by a second machine learning model, a response to the message based on the context; and providing, via the user interface of the user device, the response to the message to the first user on behalf of the second user.

Example 10. The method of Example 9, comprising: detecting, using the first machine learning model, a resolution to the price negotiation based on one or more messages exchanged between the first user and the second user subsequent to providing the response to the first user; and in response to detecting the resolution, automatically executing a transaction for the item between the first user and the second user.

Example 11. The method of any one or more of Examples 9 or 10, wherein automatically executing the transaction comprises: adjusting a price of the item; and transmitting an order confirmation to the user device.

Example 12. The method of any one or more of Examples 9-11, wherein: the message is a first message; the response is a second message; the method comprises: receiving, via the user interface of the user device of the first user, a second message subsequent to providing the response to the first user; determining, using the first machine learning model, the second message does not comprise a resolution to the price negotiation; and in response to determining the second message does not comprise a resolution to the price negotiation, generating, using the second machine learning model, a second response to the second message.

Example 13. The method of any one or more of Examples 9-12, comprising updating the second machine learning model based on determining the second message does not comprise a resolution to the price negotiation.

Example 14. The method of any one or more of Examples 9-13, wherein the generating of context comprises obtaining and combining one or more of: user data, market trend data, and platform policy data, the user data including information about the first user and the second user, the information comprising one or more of: purchase history, user preferences, negotiation patterns, inventory levels, pricing history, and profit margins, the market trend data comprising competitor pricing data, demand fluctuation data, and seasonality data, the platform policy data comprising return policies, shipping terms, and discount limits.

Example 15. The method of any one or more of Examples 9-14, comprising performing sentiment analysis on the message, wherein the generating of the response is further based on a result of the sentiment analysis.

Example 16. The method of any one or more of Examples 9-15, wherein the generating of the message comprises identifying a complementary item associated with the item, wherein the messages comprises an identifier of the complementary item.

Example 17. A machine-storage medium comprising instructions which, when executed by one or more processors of a machine, cause the machine to perform operations comprising: receiving, via a user interface of a user device of a first user, a message from the first user for sending to a second user, the message pertaining to an item corresponding to an item listing; classifying, by a first machine learning model trained to classify an intention of messages, the message as requested price negotiation for the item; based on classifying the message as requested price negotiation, generating context for the requested price negotiation for the item; generating, by a second machine learning model, a response to the message based on the context; and providing, via the user interface of the user device, the response to the message to the first user on behalf of the second user.

Example 18. The machine-storage medium of Example 17, comprising: detecting, using the first machine learning model, a resolution to the price negotiation based on one or more messages exchanged between the first user and the second user subsequent to providing the response to the first user; and in response to detecting the resolution, automatically executing a transaction for the item between the first user and the second user.

Example 19. The machine-storage medium of any one or more of Examples 17 or 18, wherein automatically executing the transaction comprises: adjusting a price of the item; and transmitting an order confirmation to the user device.

Example 20. The machine-storage medium of any one or more of Examples 17-19, wherein: the message is a first message; the response is a second message; the operations comprise: receiving, via the user interface of the user device of the first user, a second message subsequent to providing the response to the first user; determining, using the first machine learning model, the second message does not comprise a resolution to the price negotiation; and in response to determining the second message does not comprise a resolution to the price negotiation, generating, using the second machine learning model, a second response to the second message.

FIG. 10 depicts an ML pipeline 1000 and FIG. 11 illustrates training and use of an ML program 1102 (e.g., the first ML model 250 or the second ML model 280), in accordance with some examples. The ML pipeline 1000 can be used to generate a trained model such as the trained ML program 1102 (e.g., the first ML model 250 and/or the second ML model 280) to perform operations associated with schematic data capture.

ML may involve using computer algorithms to automatically learn patterns and relationships in data, potentially without the need for explicit programming. ML algorithms can be divided into four main categories: supervised learning, unsupervised learning, self-supervised learning, and reinforcement learning.

For example, supervised learning involves training a model using labeled data (e.g., labeled messages from chat histories) to predict an output for new, unseen inputs. Examples of supervised learning algorithms include linear regression, decision trees, and neural networks.

Unsupervised learning involves training a model on unlabeled data to find hidden patterns and relationships in the data. Examples of unsupervised learning algorithms include clustering, principal component analysis, and generative models like autoencoders.

Reinforcement learning involves training a model to make decisions in a dynamic environment by receiving feedback in the form of rewards or penalties. Examples of reinforcement learning algorithms include Q-learning and policy gradient methods.

Examples of specific ML algorithms that may be deployed, according to some examples, include logistic regression, which is a type of supervised learning algorithm used for binary classification tasks. Logistic regression models the probability of a binary response variable based on one or more predictor variables. Another example type of ML algorithm is Naïve Bayes, which is another supervised learning algorithm used for classification tasks. Naïve Bayes is based on Bayes'theorem and assumes that the predictor variables are independent of each other. Random Forest is another type of supervised learning algorithm used for classification, regression, and other tasks. Random Forest builds a collection of decision trees and combines their outputs to make predictions.

Further examples include neural networks, which consist of interconnected layers of nodes (or neurons) that process information and make predictions based on the input data.

Matrix factorization is another type of ML algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of ML algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of ML models is typically evaluated on a separate test set of data that was not used during training to ensure that the model can generalize to new, unseen data. For example, the performance of the first ML model 250 can be evaluated using a separate validation set to ensure it generalizes well to new, unseen messages and message patterns.

Although several specific examples of ML algorithms are discussed herein, the principles discussed herein can be applied to other ML algorithms as well. Deep learning algorithms such as convolutional neural networks, recurrent neural networks, and transformers, as well as more traditional ML algorithms like decision trees, random forests, and gradient boosting may be used in various ML applications.

Two example types of problems in ML are classification problems and regression problems. Classification problems, also referred to as categorization problems, aim at classifying items into one of several category values (e.g., is this object an apple or an orange?). Regression algorithms aim at quantifying some items (for example, by providing a value that is a real number).

Turning to the training phase 1104 as described and depicted in connection with FIG. 11 and performed, at least in part, by the model training component 290, in some examples, generating a trained ML program 1102 (e.g., the first ML model 250 and/or the second ML model 280) may include multiple phases that form part of the ML pipeline 1000, including for example the following phases illustrated in FIG. 10: data collection and preprocessing 1002, feature engineering 1004, model selection and training 1006, model evaluation 1008, prediction 1010, validation, refinement, or retraining 1012, and deployment 1014, or a combination thereof.

For example, data collection and preprocessing 1002 can include a phase for acquiring and cleaning data to ensure that it is suitable for use in the trained ML program 1102 (e.g., the first ML model 250 and/or the second ML model 280). This phase may also include removing duplicates, handling missing values, and converting data into a suitable format. Feature engineering 1004 can include a phase for selecting and transforming training data (e.g., chat histories) to create features that are useful for predicting the target variable. Feature engineering may include (1) receiving features 1108 (e.g., as structured or labeled data in supervised learning) and/or (2) identifying features 1108 (e.g., unstructured, or unlabeled data for unsupervised learning) in training data. Model selection and training 1006 can include a phase for selecting an appropriate ML algorithm and training it on the preprocessed data. This phase may further involve splitting the data into training and testing sets, using cross-validation to evaluate the model, and tuning hyperparameters to improve performance.

In additional examples, model evaluation 1008 can include a phase for evaluating the performance of a trained model (e.g., the trained ML program 1102,) on a separate testing dataset. This phase can help determine if the model is overfitting or underfitting and determine whether the model is suitable for deployment. The prediction 1010 phase includes using a trained model (e.g., trained ML program 1102) to generate predictions on new, unseen data. Validation, refinement, or retraining 1012 can include a phase for updating a model based on feedback generated from the prediction phase, such as new data, incoming user messages, user feedback, or input from a verification agent 260. Deployment 1014 can include a phase for integrating the trained model (e.g., the trained ML program 1102) into a more extensive system or application, such as the messaging system 126 or another web service, a mobile app, or an IoT device. This phase can involve setting up APIs, building a user interface, and ensuring that the model is scalable and can handle large volumes of data.

FIG. 11 illustrates further details of two example phases, namely a training phase 1104 (e.g., part of the model selection and training 1006), which is an example of the model training performed by the model training component 290, and a prediction 1110 phase (part of the prediction 1010 phase). Prior to the training phase 1104, feature engineering 1004 is used to identify features 1108. This may include identifying informative, discriminating, and independent features for effectively operating the trained ML program 1102 in pattern recognition, classification, and regression. In some examples, the training data 1106 (e.g., chat histories), includes labeled data, known for pre-identified features 1108 and one or more outcomes (e.g., transaction outcomes). Each of the features 1108 may be a variable or attribute, such as an individual measurable property of a process, article, system, or phenomenon represented by a data set (e.g., the training data 1106). Features 1108 may also be of different types, such as numeric features, strings, and graphs, and may include one or more of content 1112, concepts 1114, attributes 1116, historical data 1118, and/or user data 1120, merely for example and not limitation.

In the training phase 1104, the ML pipeline 1000 uses the training data 1106 to find correlations among the features 1108 that affect a predicted outcome or prediction/inference data 1122. By way of non-limiting example, the training data 1106 can include data stored by the databases 295 such as a corpus of messages from multiple chat histories between users of the messaging system 126.

With the training data 1106 and the identified features 1108, the trained ML program 1102 is trained during the training phase 1104 during ML program training 1124. The ML program training 1124 appraises values of the features 1108 as they correlate to the training data 1106. The result of the training is the trained ML program 1102 (e.g., a trained or learned model such as first ML model 250 or the second ML Model 280).

Further, the training phase 1104 may involve ML, in which the training data 1106 is structured (e.g., labeled during preprocessing operations). The trained ML program 1102 implements a neural network 1126 capable of performing, for example, classification and clustering operations. In other examples, the training phase 1104 may involve deep learning, in which the training data 1106 is unstructured, and the trained ML program 1102 implements a deep neural network 1126 that can perform both feature extraction and classification/clustering operations.

In some examples, a neural network 1126 may be generated during the training phase 1104 and implemented within the trained ML program 1102. The neural network 1126 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 1126 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 1126 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1104, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset. The validation dataset may also include one or more chat histories as well as associated reviews and other transaction outcomes such as refunds or discounts being issued.

Once a model is fully trained and validated, in a testing phase, the model may be tested on a new dataset. The testing dataset is used to evaluate the model's performance and ensure that the model has not overfitted the training data.

In the prediction 1010 phase, the trained ML program 1102 uses the features 1108 for analyzing query data 1128 to generate inferences, outcomes, or predictions, as examples of a prediction/inference data 1122. For example, during prediction 1010 phase, the trained ML program 1102 generates an output. Query data 1128 is provided as an input to the trained ML program 1102, and the trained ML program 1102 generates the prediction/inference data 1122 as output, responsive to receipt of the query data 1128.

In some examples, the trained ML program 1102 may be a generative AI model such as an LLM. Generative AI is a term that may refer to any type of artificial intelligence that can create new content from training data 1106. For example, generative AI can produce text, images, video, audio, code, or synthetic data similar to the original data but not identical.

Some of the techniques that may be used in generative AI are: Convolutional Neural Networks, Recurrent Neural Networks, generative adversarial networks, variational autoencoders, transformer models, and the like. For example, Convolutional Neural Networks (CNNs) can be used for image recognition and computer vision tasks. CNNs may, for example, be designed to extract features from images by using filters or kernels that scan the input image and highlight important patterns. Recurrent Neural Networks (RNNs) can be used for processing sequential data, such as speech, text, and time series data, for example. RNNs employ feedback loops that allow them to capture temporal dependencies and remember past inputs. Generative adversarial networks (GANs) can include two neural networks: a generator and a discriminator. The generator network attempts to create realistic content that can “fool” the discriminator network, while the discriminator network attempts to distinguish between real and fake content. The generator and discriminator networks compete with each other and improve over time. Variational autoencoders (VAEs) can encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models can use attention mechanisms to learn the relationships between different parts of input data (such as words or pixels) and generate output data based on these relationships. Transformer models can handle sequential data, such as text or speech, as well as non-sequential data, such as images or code. In generative AI examples, the output prediction/inference data 1122 can include predictions, translations, summaries, media content, and the like, or some combination thereof.

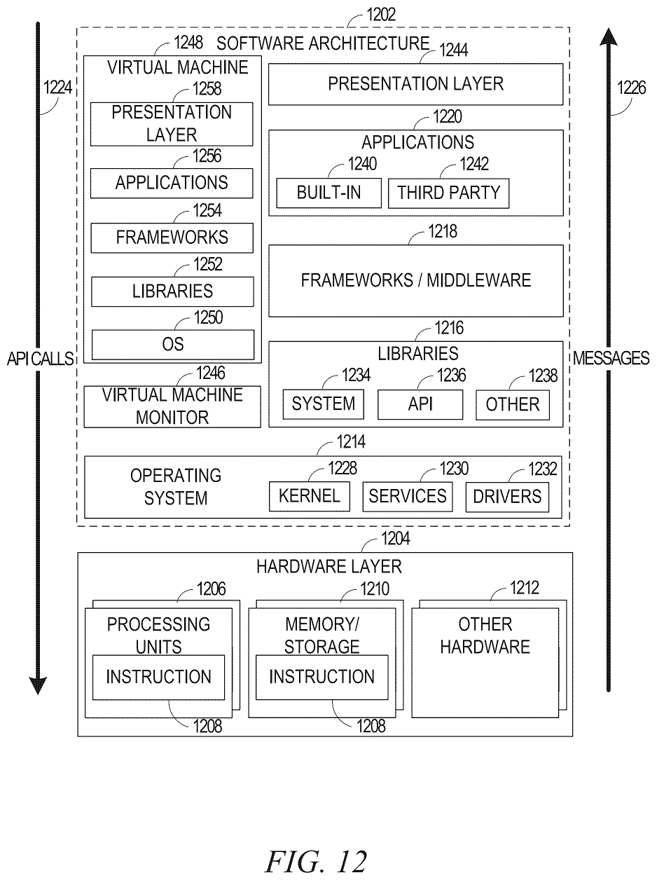

FIG. 12 is a block diagram illustrating an example of a software architecture 1202 that may be installed on a machine, according to some examples. FIG. 12 is merely a non-limiting example of software architecture, and it will be appreciated that many other architectures may be implemented to facilitate the functionality described herein. The software architecture 1202 may be executing on hardware such as a machine 1300 of FIG. 13 that includes, among other things, processors 1310, memory 1330, and input/output (I/O) components 1350. A representative hardware layer 1204 is illustrated and can represent, for example, the machine 1300 of FIG. 13. The representative hardware layer 1204 comprises one or more processing units 1206 having associated executable instructions 1208. The executable instructions 1208 represent the executable instructions of the software architecture 1202. The hardware layer 1204 also includes memory or storage modules 1210, which also have the executable instructions 1208. The hardware layer 1204 may also comprise other hardware 1212, which represents any other hardware of the hardware layer 1204, such as the other hardware illustrated as part of the machine 1300.

In the example architecture of FIG. 12, the software architecture 1202 may be conceptualized as a stack of layers, where each layer provides particular functionality. For example, the software architecture 1202 may include layers such as an operating system 1214, libraries 1216, frameworks/middleware 1218, applications 1220, and a presentation layer 1244. Operationally, the applications 1220 or other components within the layers may invoke API calls 1224 through the software stack and receive a response, returned values, and so forth (illustrated as messages 1226) in response to the API calls 1224. The layers illustrated are representative in nature, and not all software architectures have all layers. For example, some mobile or special-purpose operating systems may not provide a frameworks/middleware 1218 layer, while others may provide such a layer. Other software architectures may include additional or different layers.

The operating system 1214 may manage hardware resources and provide common services. The operating system 1214 may include, for example, a kernel 1228, services 1230, and drivers 1232. The kernel 1228 may act as an abstraction layer between the hardware and the other software layers. For example, the kernel 1228 may be responsible for memory management, processor management (e.g., scheduling), component management, networking, security settings, and so on. The services 1230 may provide other common services for the other software layers. The drivers 1232 may be responsible for controlling or interfacing with the underlying hardware. For instance, the drivers 1232 may include display drivers, camera drivers, Bluetooth® drivers, flash memory drivers, serial communication drivers (e.g., Universal Serial Bus [USB] drivers), Wi-Fi® drivers, audio drivers, power management drivers, and so forth depending on the hardware configuration.

The libraries 1216 may provide a common infrastructure that may be utilized by the applications 1220 and/or other components and/or layers. The libraries 1216 typically provide functionality that allows other software modules to perform tasks in an easier fashion than by interfacing directly with the underlying operating system 1214 functionality (e.g., kernel 1228, services 1230, or drivers 1232). The libraries 1216 may include system libraries 1234 (e.g., C standard library) that may provide functions such as memory allocation functions, string manipulation functions, mathematic functions, and the like. In addition, the libraries 1216 may include API libraries 1236 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1216 may also include a wide variety of other libraries 1238 to provide many other APIs to the applications 1220 and other software components/modules.

The frameworks 1218 (also sometimes referred to as middleware) may provide a higher-level common infrastructure that may be utilized by the applications 1220 or other software components/modules. For example, the frameworks 1218 may provide various graphical user interface functions, high-level resource management, high-level location services, and so forth. The frameworks 1218 may provide a broad spectrum of other APIs that may be utilized by the applications 1220 and/or other software components/modules, some of which may be specific to a particular operating system or platform.

The applications 1220 include built-in applications 1240 and/or third-party applications 1242. Examples of representative built-in applications 1240 may include, but are not limited to, a home application, a contacts application, a browser application, a book reader application, a location application, a media application, a messaging application, or a game application.

The third-party applications 1242 may include any of the built-in applications 1240, as well as a broad assortment of other applications. In a specific example, the third-party applications 1242 (e.g., an application developed using the Android™ or iOS™ software development kit [SDK] by an entity other than the vendor of the particular platform) may be mobile software running on a mobile operating system such as iOS™, Android™, or other mobile operating systems. In this example, the third-party applications 1242 may invoke the API calls 1224 provided by the mobile operating system such as the operating system 1214 to facilitate functionality described herein.

The applications 1220 may utilize built-in operating system functions (e.g., kernel 1228, services 1230, or drivers 1232), libraries (e.g., system libraries 1234, API libraries 1236, and other libraries 1238), or frameworks/middleware 1218 to create user interfaces to interact with users of the system. Alternatively, or additionally, in some systems, interactions with a user may occur through a presentation layer, such as the presentation layer 1244. In these systems, the application/module “logic” can be separated from the aspects of the application/module that interact with the user.

Some software architectures utilize virtual machines. In the example of FIG. 12, this is illustrated by a virtual machine 1248. The virtual machine 1248 creates a software environment where applications/modules can execute as if they were executing on a hardware machine (e.g., the machine 1300 of FIG. 13). The virtual machine 1248 is hosted by a host operating system (e.g., the operating system 1214) and typically, although not always, has a virtual machine monitor 1246, which manages the operation of the virtual machine 1248 as well as the interface with the host operating system (e.g., the operating system 1214). A software architecture executes within the virtual machine 1248, such as an operating system 1250, libraries 1252, frameworks 1254, applications 1256, or a presentation layer 1258. These layers of software architecture executing within the virtual machine 1248 can be the same as corresponding layers previously described or may be different.

FIG. 13 illustrates a diagrammatic representation of a machine 1300 in the form of a computer system within which a set of instructions may be executed for causing the machine 1300 to perform any one or more of the methodologies discussed herein, according to some examples. Specifically, FIG. 13 shows a diagrammatic representation of the machine 1300 in the example form of a computer system, within which instructions 1316 (e.g., software, a program, an application, an applet, an app, or other executable code) for causing the machine 1300 to perform any one or more of the methodologies discussed herein may be executed. For example, the instructions 1316 may cause the machine 1300 to execute any one or more of the process 300, the process 400, the method 500 or the method 900 described above. The instructions 1316 transform the general, non-programmed machine 1300 into a particular machine 1300 programmed to carry out the described and illustrated functions in the manner described. In alternative examples, the machine 1300 operates as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 1316, sequentially or otherwise, that specify actions to be taken by the machine 1300. Further, while only a single machine 1300 is illustrated, the term “machine” shall also be taken to include a collection of machines 1300 that individually or jointly execute the instructions 1316 to perform any one or more of the methodologies discussed herein.

The machine 1300 may include processors 1310, memory 1330, and I/O components 1350, which may be configured to communicate with each other such as via a bus 1302. In an example, the processors 1310 (e.g., a hardware processor, such as a central processing unit [CPU], a reduced instruction set computing [RISC] processor, a complex instruction set computing [CISC] processor, a graphics processing unit [GPU], a digital signal processor [DSP], an application-specific integrated circuit [ASIC], a radio-frequency integrated circuit [RFIC], another processor, or any suitable combination thereof) may include, for example, a processor 1312 and a processor 1314 that may execute the instructions 1316. The term “processor” is intended to include multi-core processors that may comprise two or more independent processors (sometimes referred to as “cores”) that may execute instructions contemporaneously. Although FIG. 13 shows multiple processors 1310, the machine 1300 may include a single processor with a single core, a single processor with multiple cores (e.g., a multi-core processor), multiple processors with a single core, multiple processors with multiples cores, or any combination thereof.

The memory 1330 may include a main memory 1332, a static memory 1334, and a storage unit 1336 including machine-readable medium 1338, each accessible to the processors 1310 such as via the bus 1302. The main memory 1332, the static memory 1334, and the storage unit 1336 store the instructions 1316 embodying any one or more of the methodologies or functions described herein. The instructions 1316 may also reside, completely or partially, within the main memory 1332, within the static memory 1334, within the storage unit 1336, within at least one of the processors 1310 (e.g., within the processor's cache memory), or any suitable combination thereof, during execution thereof by the machine 1300.

The I/O components 1350 may include a wide variety of components to receive input, provide output, produce output, transmit information, exchange information, capture measurements, and so on. The specific I/O components 1350 that are included in a particular machine will depend on the type of machine. For example, portable machines such as mobile phones will likely include a touch input device or other such input mechanisms, while a headless server machine will likely not include such a touch input device. It will be appreciated that the I/O components 1350 may include many other components that are not shown in FIG. 13. The I/O components 1350 are grouped according to functionality merely for simplifying the following discussion, and the grouping is in no way limiting. In some examples, the I/O components 1350 may include output components 1352 and input components 1354. The output components 1352 may include visual components (e.g., a display such as a plasma display panel [PDP], a light-emitting diode [LED] display, a liquid crystal display [LCD], a projector, or a cathode ray tube [CRT]), acoustic components (e.g., speakers), haptic components (e.g., a vibratory motor, resistance mechanisms), other signal generators, and so forth. The input components 1354 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 1350 may include biometric components 1356, motion components 1358, environmental components 1360, or position components 1362, among a wide array of other components. The motion components 1358 may include acceleration sensor components (e.g., accelerometer), gravitation sensor components, rotation sensor components (e.g., gyroscope), and so forth. The environmental components 1360 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1362 may include location sensor components (e.g., a Global Positioning System [GPS] receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1350 may include communication components 1364 operable to couple the machine 1300 to a network 1380 or devices 1370 via a coupling 1382 and a coupling 1372, respectively. For example, the communication components 1364 may include a network interface component or another suitable device to interface with the network 1380. In further examples, the communication components 1364 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1370 may be another machine or any of a wide variety of peripheral devices (e.g., a peripheral device coupled via a USB).

Moreover, the communication components 1364 may detect identifiers or include components operable to detect identifiers. For example, the communication components 1364 may include radio frequency identification (RFID) tag reader components, NFC smart tag detection components, optical reader components (e.g., an optical sensor to detect one-dimensional bar codes such as Universal Product Code [UPC] bar code, multi-dimensional bar codes such as Quick Response [QR] code, Aztec code, Data Matrix, Dataglyph, MaxiCode, Ultra Code, UCC RSS-2D bar code, and other optical codes), or acoustic detection components (e.g., microphones to identify tagged audio signals). In addition, a variety of information may be derived via the communication components 1364, such as location via Internet Protocol (IP) geolocation, location via Wi-Fi® signal triangulation, location via detecting an NFC beacon signal that may indicate a particular location, and so forth.

Certain examples are described herein as including logic or a number of components, modules, elements, or mechanisms. Such components can constitute either software components (e.g., code embodied on a machine-readable medium or in a transmission signal) or hardware components. A “hardware component” is a tangible unit capable of performing certain operations and can be configured or arranged in a certain physical manner. In various example embodiments, one or more computer systems (e.g., a standalone computer system, a client computer system, or a server computer system) or one or more hardware components of a computer system (e.g., a processor or a group of processors) are configured by software (e.g., an application or application portion) as a hardware component that operates to perform certain operations as described herein.

In some examples, a hardware component is implemented mechanically, electronically, or any suitable combination thereof. For example, a hardware component can include dedicated circuitry or logic that is permanently configured to perform certain operations. For example, a hardware component can be a special-purpose processor, such as a field-programmable gate array (FPGA) or an ASIC. A hardware component may also include programmable logic or circuitry that is temporarily configured by software to perform certain operations. For example, a hardware component can include software encompassed within a general-purpose processor or other programmable processor. It will be appreciated that the decision to implement a hardware component mechanically, in dedicated and permanently configured circuitry, or in temporarily configured circuitry (e.g., configured by software) can be driven by cost and time considerations.

Accordingly, the phrase “component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software can accordingly configure a particular processor or processors, for example, to constitute a particular hardware component at one instance of time and to constitute a different hardware component at a different instance of time.

Hardware components can provide information to, and receive information from, other hardware components. Accordingly, the described hardware components can be regarded as being communicatively coupled. Where multiple hardware components exist contemporaneously, communications can be achieved through signal transmission (e.g., over appropriate circuits and buses) between or among two or more of the hardware components. In examples in which multiple hardware components are configured or instantiated at different times, communications between or among such hardware components may be achieved, for example, through the storage and retrieval of information in memory structures to which the multiple hardware components have access. For example, one hardware component performs an operation and stores the output of that operation in a memory device to which it is communicatively coupled. A further hardware component can then, at a later time, access the memory device to retrieve and process the stored output. Hardware components can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented components that operate to perform one or more operations or functions described herein. As used herein, “processor-implemented component” refers to a hardware component implemented using one or more processors.

Similarly, the methods described herein can be at least partially processor-implemented, with a particular processor or processors being an example of hardware. For example, at least some of the operations of a method can be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines 1300 including processors 1310), with these operations being accessible via a network (e.g., the Internet) and via one or more appropriate interfaces (e.g., an API). In certain embodiments, for example, a client device may relay or operate in communication with cloud computing systems and may access circuit design information in a cloud environment.

The performance of certain of the operations may be distributed among the processors, not only residing within a single machine 1300, but deployed across a number of machines 1300. In some examples, the processors 1310 or processor-implemented components are located in a single geographic location (e.g., within a home environment, an office environment, or a server farm). In other example embodiments, the processors or processor-implemented components are distributed across a number of geographic locations.

The various memories (i.e., 1330, 1332, 1334, and/or the memory of the processor[s] 1310) and/or the storage unit 1336 may store one or more sets of instructions 1316 and data structures (e.g., software) embodying or utilized by any one or more of the methodologies or functions described herein. These instructions (e.g., the instructions 1316), when executed by the processor(s) 1310, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1316 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below.

In some examples, one or more portions of the network 1380 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1380 or a portion of the network 1380 may include a wireless or cellular network, and the coupling 1382 may be a Code Division Multiple Access (CDMA) connection, a Global System for Mobile communications (GSM) connection, or another type of cellular or wireless coupling. In this example, the coupling 1382 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol [HTTP]). Similarly, the instructions may be transmitted or received using a transmission medium via the coupling (e.g., a peer-to-peer coupling) to the devices 1370. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, data stores, and other components are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

1. A system comprising:
one or more hardware processors; and
a memory storing instructions that, when executed by the one or more processors, cause the one or more processors to perform operations comprising:
receiving, via a user interface of a user device of a first user, a message from the first user for sending to a second user, the message pertaining to an item corresponding to an item listing;
classifying, by a first machine learning model trained to classify an intention of messages, the message as requested price negotiation for the item;
based on classifying the message as requested price negotiation, generating context for the requested price negotiation for the item, wherein the context comprises a structured representation generated from multiple heterogeneous data sources associated with the users and the item;
generating, by a second machine learning model, a response to the message based on the context; and
providing, via the user interface of the user device, the response to the message to the first user on behalf of the second user
detecting a terminal condition in a sequence of user messages using the second machine learning model; and
triggering execution of a system operation associated with the item in response to detection of the terminal condition.

2. The system of claim 1, wherein
detecting the terminal condition comprises detecting, using the second machine learning model, a resolution to the price negotiation based on one or more messages exchanged between the first user and the second user subsequent to providing the response to the first user, and wherein triggering execution of the system operation comprises automatically executing a transaction for the item between the first user and the second user.

3. The system of claim 2, wherein automatically executing the transaction comprises:
adjusting a price of the item; and
transmitting an order confirmation to the user device.

4. The system of claim 1, wherein:
the message is a first message;
the response is a second message;
the operations comprise:
receiving, via the user interface of the user device of the first user, the second message subsequent to providing the response to the first user;
determining, using the second machine learning model that the terminal condition has not been detected based on the second message and
in response to determining that the terminal condition has not been detected, generating, using the second machine learning model, a third response to the second message.

5. The system of claim 4, wherein the operations comprise updating the second machine learning model based on determining that the terminal condition has not been detected based on the second message.

6. The system of claim 1, wherein the multiple heterogeneous data sources comprise two or more of: user data, market trend data, and platform policy data, the user data including information about the first user and the second user, the information comprising one or more of: purchase history, user preferences, negotiation patterns, inventory levels, pricing history, and profit margins, the market trend data comprising competitor pricing data, demand fluctuation data, and seasonality data, the platform policy data comprising return policies, shipping terms, and discount limits.

7. The system of claim 1, wherein the operations comprise performing sentiment analysis on the message, wherein the generating of the response is further based on a result of the sentiment analysis.

8. The system of claim 1, wherein the generating of the response comprises identifying a complementary item associated with the item, wherein the response comprises an identifier of the complementary item.

9. A method comprising:
receiving, via a user interface of a user device of a first user, a message from the first user for sending to a second user, the message pertaining to an item corresponding to an item listing;
classifying, by a first machine learning model trained to classify an intention of messages, the message as requested price negotiation for the item;
based on classifying the message as requested price negotiation, generating, by at least one hardware processor, context for the requested price negotiation for the item, wherein the context comprises a structured representation generated from multiple heterogeneous data sources associated with the users and the item;
generating, by a second machine learning model, a response to the message based on the context;
providing, via the user interface of the user device, the response to the message to the first user on behalf of the second user;
detecting a terminal condition in a sequence of user messages using the second machine learning model; and
triggering execution of a system operation associated with the item in response to detection of the terminal condition.

10. The method of claim 9,
wherein detecting the terminal condition comprises detecting, using the second machine learning model, a resolution to the price negotiation based on one or more messages exchanged between the first user and the second user subsequent to providing the response to the first user, and wherein triggering execution of the system operation comprises automatically executing a transaction for the item between the first user and the second user.

11. The method of claim 10, wherein automatically executing the transaction comprises:
adjusting a price of the item; and
transmitting an order confirmation to the user device.

12. The method of claim 9, wherein:
the message is a first message;
the response is a second message;
the method comprises:
receiving, via the user interface of the user device of the first user, the second message subsequent to providing the response to the first user;
determining, using the second machine learning model that the terminal condition has not been detected based on the second message; and
in response to determining that the terminal condition has not been detected generating, using the second machine learning model, a third response to the second message.

13. The method of claim 11, comprising updating the second machine learning model based on determining that the terminal condition has not been detected based on the second message.

14. The method of claim 9, wherein the multiple heterogeneous data sources comprise two or more of: user data, market trend data, and platform policy data, the user data including information about the first user and the second user, the information comprising one or more of: purchase history, user preferences, negotiation patterns, inventory levels, pricing history, and profit margins, the market trend data comprising competitor pricing data, demand fluctuation data, and seasonality data, the platform policy data comprising return policies, shipping terms, and discount limits.

15. The method of claim 9, comprising performing sentiment analysis on the message, wherein the generating of the response is further based on a result of the sentiment analysis.

16. The method of claim 9, wherein the generating of the response comprises identifying a complementary item associated with the item, wherein the response comprises an identifier of the complementary item.

17. A non-transitory computer-readable storage medium comprising instructions which, when executed by one or more processors of a machine, cause the machine to perform operations comprising:
receiving, via a user interface of a user device of a first user, a message from the first user for sending to a second user, the message pertaining to an item corresponding to an item listing;
classifying, by a first machine learning model trained to classify an intention of messages, the message as requested price negotiation for the item;
based on classifying the message as requested price negotiation, generating context for the requested price negotiation for the item, wherein the context comprises a structured representation generated from multiple heterogeneous data sources associated with the users and the item;
generating, by a second machine learning model, a response to the message based on the context; providing, via the user interface of the user device, the response to the message to the first user on behalf of the second user;
detecting a terminal condition in a sequence of user messages using the second machine learning model; and
triggering execution of a system operation associated with the item in response to detection of the terminal condition.

18. The non-transitory computer-readable storage medium of claim 17,
wherein detecting the terminal condition comprises detecting, using the second machine learning model, a resolution to the price negotiation based on one or more messages exchanged between the first user and the second user subsequent to providing the response to the first user, and wherein triggering execution of the system operation comprises automatically executing a transaction for the item between the first user and the second user.

19. The non-transitory computer-readable storage medium of claim 18, wherein automatically executing the transaction comprises:
adjusting a price of the item; and
transmitting an order confirmation to the user device.

20. The non-transitory computer-readable storage medium of claim 17, wherein:
the message is a first message;
the response is a second message;
the operations comprise:
receiving, via the user interface of the user device of the first user, the second message subsequent to providing the response to the first user;
determining, using the second machine learning model that the terminal condition has not been detected based on the second message; and
in response to determining that the terminal condition has not been detected, generating, using the second machine learning model, a third response to the second message.
